(19) United States
(12) Patent Application Publication
(10) Pub. No.: US 2020/0323390 A1
(43) Pub. Date: Oct. 15, 2020

(54) Cooking Apparatus and Cooking System

(71) Applicant: Zhengxu He, Reno, NV (US)

(72) Inventor: Zhengxu He, Reno, NV (US)

(21) Appl. No.: 16/510,982

(22) Filed: Jul. 15, 2019

Related U.S. Application Data
(60) Provisional application No. 62/833,005, filed on Apr. 12, 2019.

(51) Int. Cl. A47J 37/12

(52) U.S. Cl. CPC A47J 37/1228; A47J 37/1266

(57) ABSTRACT

The present application firstly discloses cooking apparatuses capable of producing a cooked food using semi-cooked food as ingredients. Secondly, a cooking system may comprise more than one cooking apparatuses, each capable of cooking of food ingredients. They work together to produce a cooked food from food ingredients. A computer system is configured to control such cooking system.

This application claims the benefit of U.S. Provisional Application Ser. No. 62/833,005, filed Apr. 12, 2019. Entire contents of the above application are incorporated herein by reference.

### CROSS-REFERENCE TO RELATED APPLICATIONS

U.S. PROVISIONAL PATENT APPLICATIONS: Ser. No. 62/833,005, Filed Apr. 12, 2019, Inventor: Zhengxu

### BACKGROUND OF THE INVENTION

The present application relates to a cooking system for producing a food from food ingredients.

In cooking of a food item, one or more of the following steps are required: (1) a first food ingredient is stir fried or otherwise cooked in a wok or other cookware; (2) a second food ingredient is deep fried in hot oil or boiled in hot water; (3) a third food ingredient deep fried in hot oil is boiled in hot water; (4) the first and second food ingredients, after being deep fried in oil and boiled in hot water, are dispensed into the wok, adding to the third food ingredient; (5) all food ingredients are then stirred and/or mixed in the wok, as to produce a cooked food; (6) the cooked food is then dispensed into a food container, such as, a plate or a bowl.

A cost-effective cooking apparatus or cooking system that does (some or) all of the above steps is very important, as it can save labor and cost.

Furthermore, a cost-effective transportation of the first, second and third food ingredients to the deep fryer, hot water cookware or wok, respectively, is also very important for the same reason.

The automation of such cooking system depends on new computer algorithms.

### BRIEF SUMMARY OF THE INVENTION

A cooking system in our application comprises some cooking apparatuses and other mechanisms and/or apparatuses. The present patent application discloses some cooking apparatuses comprising one or more of the following parts: (1) a first cookware configured to contain or otherwise hold food or food ingredients for the purpose of cooking a food, and a stirring mechanism configured to move the first cookware as to stir or mix the food ingredients contained in the cookware; (2) an unloading mechanism configured to directly or indirectly move the first cookware, as to dispense a cooked food into a food container; (3) a receiving mechanism configured to hold a food container so the unloading mechanism may dispense a cooked food from the first cookware into the food container; (4) a second cookware configured to hold a liquid (e.g., cooking oil, water), a heater configured to heat the liquid therein, a first basket configured to contain or otherwise hold a food or food ingredient, a motion mechanism configured to move the first basket up and down, and a motion mechanism (as a second unloading mechanism) configured to move the first basket as to dispense a semi-cooked food in the first basket into the first cookware; (5) a third cookware configured to hold a liquid, a heater configured to heat the liquid therein, a basket configured to contain or otherwise hold a food or food ingredient, a motion mechanism configured to move the basket up and down, and a motion mechanism configured to dispense a semi-cooked food in the basket into the first cookware.

The first cookware may be a wok, a pan, or any container configured to contain or otherwise hold food or food ingredients during cooking.

Implementations of our cooking system may include one or more of the following. The stirring mechanism may comprise a support component and a mechanism configured to produce a motion in the cookware relative to the support component, as to stir or mix the food or food ingredients in the cookware. The stirring mechanism may comprise: a first shaft, a second shaft, a third shaft and a fourth shaft, a fifth shaft, wherein the axes of the shafts are all parallel to each other.

Implementations of our cooking system may include one or more of the following. The unloading apparatus is configured to produce a controlled axial rotation in the support component of a stirring mechanism as to dispense a cooked food from the cookware; wherein the axis of the controlled axial rotation is configured to be horizontal. The receiving apparatus may also comprise a funnel, and a rotatable turntable configured to hold a food container (e.g., a bowl), and a cleaning mechanism configured to clean the funnel, by spraying water or other cleaning liquid on the area to be cleaned.

Our cooking system may also comprise a dispensing mechanism which dispenses food or food ingredients into the first container, the first basket or the basket. The cooking system may also comprise a receiving apparatus which may hold a food container as to receive a cooked food from the first cookware, and a transfer apparatus which may move a container of cooked food to an area accessible by humans.

Implementations of our cooking system may include one or more of the following. The dispensing mechanism may comprise: (1) a first support component; (2) a gripping mechanism comprising a second support component, a plurality of gripping devices, and a mechanism configured to produce a controlled rotation in the gripping device relative to the first support component as to grab or let loose a container; (3) a mechanism configured to produce a rotation in the first support component relative to the second support component.

A computer system is used to control the above described mechanisms and apparatus.

### BRIEF DESCRIPTION OF THE SEVERAL VIEWS OF THE DRAWINGS

FIG. 1 shows a schematic view of a rotational mechanism

FIG. 2 shows a schematic view of a computer system.

FIG. 3A shows a schematic side view of a cooking apparatus comprising a cookware and a stirring mechanism. FIG. 3B shows a schematic side view of the stirring mechanism.

FIG. 4 shows a schematic side view of a cooking apparatus comprising the cooking apparatus of FIG. 3A and an unloading mechanism.

FIG. 5 shows a schematic side view of the relative position of a receiving apparatus.

FIGS. 6A-6B show schematic side views of the relative positions of the cooking apparatus of FIG. 4 and the receiving apparatus of FIG. 5.

FIG. 7A shows a schematic side view of a liquid dispensing mechanism. FIG. 7B shows a schematic side view of the relation positions of the cooking apparatus of FIG. 4 and the liquid dispensing mechanism

FIG. 8A shows a schematic side view of a cookware cleaning mechanism. FIGS. 8B-8C show schematic side views of the relative positions of the cookware cleaning mechanism and the cooking apparatus of FIG. 4.

FIG. 9A shows a schematic plane view of an ingredient dispensing mechanism. FIG. 9B shows a schematic side view of the ingredient dispensing mechanism.

FIG. 9C shows a schematic side view of a transport system. FIG. 9D shows the relative positions of the transport system and the ingredient dispensing mechanism of FIGS. 9A-9B.

FIG. 10 shows a schematic side view of the relative positions of the cooking apparatus of FIG. 4, the ingredient dispensing mechanism of FIGS. 9A-9B and the transport system of FIG. 9C.

FIG. 11 shows a schematic side view of a cooking apparatus.

FIG. 12 shows a schematic side view of a cooking apparatus.

FIGS. 13A-13B show schematic side views of a cooking apparatus comprising the cooking apparatus of FIG. 11 and the cooking apparatus of FIG. 12.

FIG. 14 shows a schematic side view of a cooking system comprising a transport system comprising, a basket, a cookware and a food container. FIG. 15A shows a schematic side view of the cooking system showing the dispensing of food ingredients from an ingredient container on the transport system into a basket; and FIG. 15B shows a zooming in view of the dispensing. FIG. 16A shows a schematic side view of the cooking system showing the dispensing of a semi-cooked food from a basket to the cookware. FIG. 16B shows a schematic side view of a zooming in view of the dispensing. FIG. 17 shows a schematic side view of the cooking system showing the dispensing of a cooked food from a cookware to a food container.

FIG. 18 is a flow chart showing the procedures of the computer system of the cooking system of FIG. 14 prior to cooking of a food.

FIG. 19 is a flow chart showing the procedures of the computer system in the cooking system of FIG. 14 during the cooking of a food.

FIG. 20 shows a schematic view of a positioning of various mechanisms and apparatuses in the cooking system of FIG. 14.

FIG. 21 shows a schematic side view of a storage apparatus which can store ingredient containers.

FIG. 22A shows a schematic plane view of a loading mechanism FIG. 22B shows a side view of the loading mechanism.

FIGS. 23A-23D show schematic side views of the relative positions of the storage apparatus of FIG. 22, the loading mechanism of FIGS. 22A-22B, and the transport system of FIG. 9C.

FIG. 24 shows a schematic side view of a cooking system comprising two cookware and two stirring mechanisms. FIG. 25 shows a schematic view of the dispensing of a semi-cooked food from one cookware to another.

FIG. 26 is a flow chart showing the procedures of the computer system of the cooking system of FIG. 24 prior to cooking a food.

FIG. 27 is a flow chart showing the procedures of the computer system in the cooking system of FIG. 24 during the cooking of a food.

FIG. 28 shows a schematic view of a positioning of various mechanisms and apparatuses in the cooking system of FIG. 24.

FIG. 29 shows a schematic side view of a cooking system.

FIG. 30A shows a schematic side view of the cooking system of FIG. 29 showing the dispensing of food ingredients from an ingredient container on the transport system into a basket; and FIG. 30B shows a zooming in view of the dispensing. FIG. 30C shows a schematic side view of the cooking system showing the dispensing of food ingredients from an ingredient container on the transport system into a basket; and FIG. 30D shows a zooming in view of the dispensing.

FIG. 31A shows a schematic side view of the cooking system of FIG. 29 showing the dispensing of a semi-cooked food from a basket to the cookware. FIG. 31B shows a schematic side view of a zooming in view of the dispensing. FIG. 31C shows a schematic side view of the cooking system showing the dispensing of a semi-cooked food from a basket to the cookware. FIG. 31D shows a schematic side view of a zooming in view of the dispensing.

FIG. 32 shows a schematic side view of the cooking system of FIG. 29 showing the dispensing of a cooked food from a cookware to a food container.

FIG. 33 is a flow chart showing the procedures of the computer system of the cooking system of FIG. 29 prior to cooking of a food.

FIG. 34 is a flow chart showing the procedures of the computer system in the cooking system of FIG. 29 during the cooking of a food.

FIG. 35 shows a schematic plane view of the cooking system of FIG. 29.

### DETAILED DESCRIPTION OF THE INVENTION

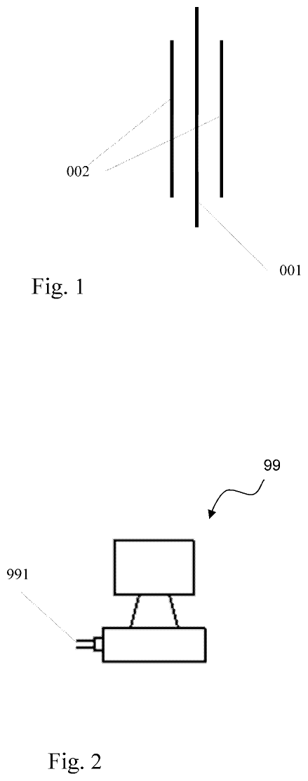

Referring to FIG. 1, for illustration purpose, a rotational mechanism comprises two mating parts 001 and 002, and a connection configured to constrain the relative motion of the mating parts to a rotation around an axis; wherein the axis of the relative rotation is relatively fixed with respect to either mating part. The axis of the relative rotation is referred to as the axis of the rotational mechanism, or the axis of the part 001, or the axis of the part 002. In many applications, the part 001 may be a shaft, and the part 002 may be a bearing housing, and the connection may comprise one or more bearings and accessories.

Various parts of our cooking apparatuses and cooking systems are described below.

Referring to FIG. 2, a computer system 99 comprises I/O ports 991 which may be connected to other electric or electronic parts including motors, inductive stoves, sensors, etc. The computer system 99 may further comprise one or more computers, programs, wireless communication ports, one or more circuit boards with various components, etc.

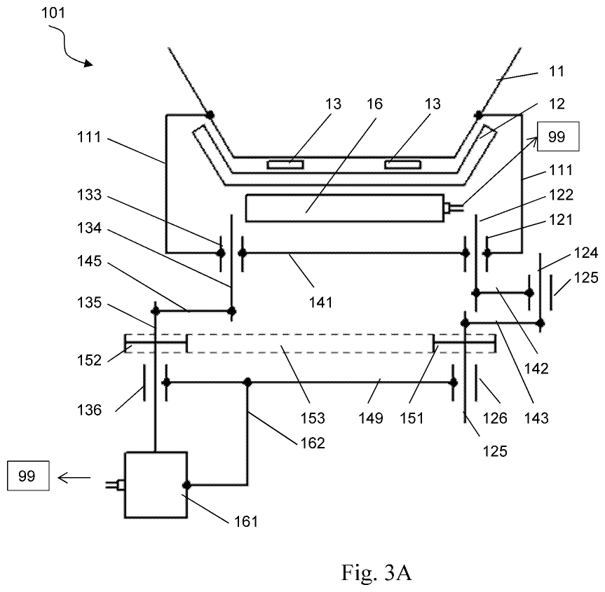

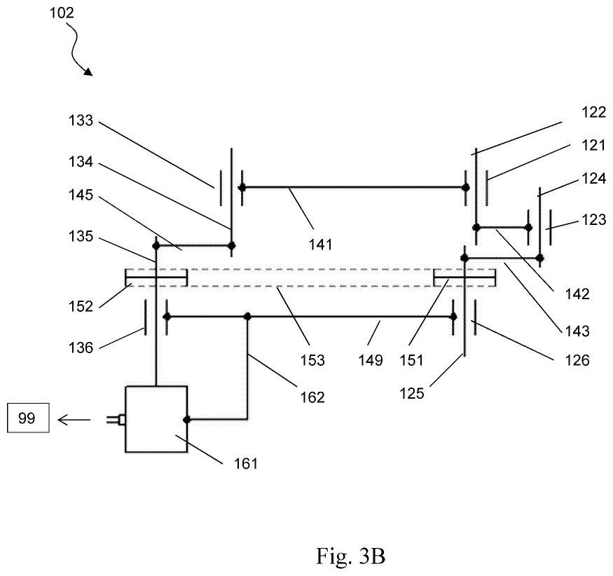

Referring to FIGS. 3A-3B, a cooking apparatus 101 comprises: a cookware 11; a heat insulation member 12; temperature sensors 13; an inductive stove 16. The cookware 11 is configured to contain or otherwise hold food or food ingredients during a cooking process, when the cookware 11 is at or near an upright position. The cookware 11 comprises ferromagnetic metal (or other ferromagnetic material) at bottom. The heat insulation member 12 and temperature sensors 13 are all fixedly connected to the cookware 11. The temperature sensors 13 are configured to sense the temperature of some surfaces of the cookware. The temperature sensors 13 are connected to the computer system 99 by wires so that the computer system 99 may be able to read or estimate the temperatures of the cookware. The inductive stove 16 is configured to heat the ferromagnetic metal in the cookware 11. The inductive stove 16 may be fixedly connected with the stove (although the connection is not shown in figure). Alternatively, the inductive stove 16 may be fixedly connected to the ground.

The cooking apparatus 101 further comprises a stirring mechanism 102, wherein stirring mechanism 102 comprises: a first rotational mechanism comprising mating parts 133 and 134; a second rotational mechanism comprising mating parts 135 and 136; a third rotational mechanism comprising mating parts 123 and 124; a fourth rotational mechanism comprising mating parts 125 and 126; a fifth rotational mechanism comprising mating parts 121 and 122; The axes of all these rotational mechanisms are configured to be parallel to each other, and the distance between the axis of the first rotational mechanism and the axis of the second rotational mechanism is configured to be equal to the distance between the third rotational mechanism and the fourth rotational mechanism See FIG. 3B.

The stirring mechanism 102 further comprises rigid connectors 141, 142, 143, 145 and 149. The connector 141 is configured to rigidly connect the parts 133 and 121. The connector 142 is configured to rigidly connect the parts 122 and 123. The connector 143 is configured to rigidly connect the parts 124 and 125. The connector 145 is configured to rigidly connect the parts 134 and 135. The connector 149 is configured to rigidly connect the parts 136 and 126.

The stirring mechanism 102 further comprises pulleys 151 and 152, and a timing belt 153. The pulley 151 is configured to be fixedly connected to the part 125 and the axis of the pulley 151 is the same as the axis of the fourth rotational mechanism, which comprises the mating parts 125 and 126. The pulley 152 is configured to be fixedly connected to the part 135, and the axis of the pulley 152 is the same as the axis of the second rotational mechanism, which comprises the mating parts 135 and 136. The pulleys 151 and 152 are configured to be coplanar, and to have the same radii. The timing belt 153 is configured to connect the pulleys 151 and 152 so that the pulleys 151 and 152 are constrained to rotate synchronously. Moreover, the plane containing the axes of the first rotational mechanism and the axis of the second rotation mechanism is configured to be parallel to the plane containing the axis of the third rotational mechanism and the axis of the fourth rotational mechanism Thus, the parts 124 and 134 are rotated synchronously.

The stirring mechanism 102 further comprises: a motorized mechanism 161 configured to produce a rotation in the mating part 135 relative to the mating part 136 in the second rotational mechanism A base component of the motorized mechanism 161 is fixedly connected to the rigid component 149 by a connector 162. The motorized mechanism 161 is connected to the computer system 99 via wires, so that the computer system 99 may control the timing and speed of the motorized mechanism.

The cooking apparatus 101 further comprises a connector 111 configured to fixedly connect the components 121, 133 and the connector 141 to the cookware 11.

The rigid connector 149 may be referred to as the support component of the stirring mechanism 102. When the motorized mechanism 161 produces a rotation in the part 135 relative to the part 136 (or equivalently, relative to the rigid component 149), the rigid connector 141 (and the parts 133 and 121) makes a circular motion without self-rotation. Each point of the rigid connector 141 (or of the parts 133 or 121) is rotated in a circular motion relative to the support component 149, and the trajectory of the point is a circle whose radius is equal to the eccentricity of the stirring mechanism, wherein the circle lies on a plane which is perpendicular to the axes of the rotational mechanisms.

It should be noted that a connection of the part 123 with the component 141 comprises the fifth rotational mechanism (comprising mating parts 121 and 122) and the connector 142. This connection may be substituted by a rigid connection. The presence of the fifth rotational mechanism in the connection is for the purpose of easing tensions and strains in the stirring mechanism when the rotations in the parts 125 and 135 are not perfectly synchronous due to manufacturing or assembly errors.

It should be noted that the motorized mechanism 161 may comprise a motor comprising a shaft and a base component, a fixed connection of the shaft of the motor with the part 135, wherein the axis of the shaft of the motor is configured to be the same as the axis of the second rotational mechanism. The connector 162 may make a fixed connection of the base component of the motor and the rigid component 149.

The distance between the axis of the first rotational mechanism and the axis of the second rotational mechanism is referred to as the eccentricity of stirring mechanism 102.

It should be noted that the parts 122, 124, 125, 134 and 135 may be shafts, and the parts 121, 123, 126, 133, 136 may be bearing housings.

In the cooking apparatus 101, the cookware 11 may be substituted by any cookware configured to contain or otherwise hold food or food ingredients when it is at or near an upright position.

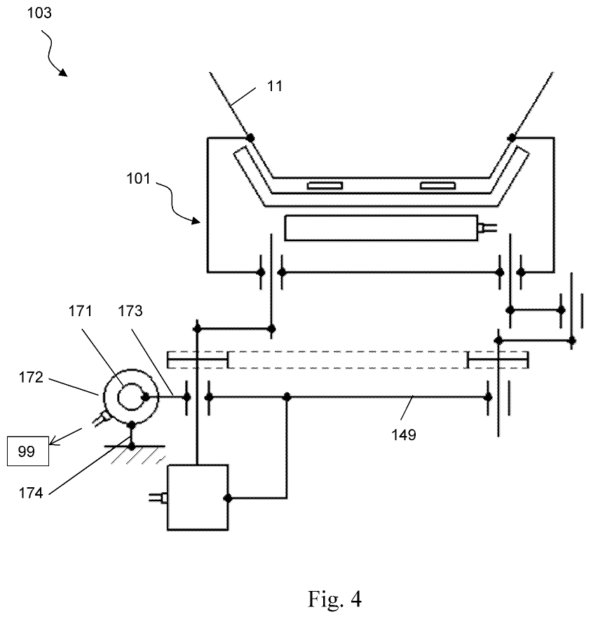

In some embodiments, referring to FIG. 4, a cooking apparatus 103 comprises a cooking apparatus 101, a shaft 171, a motorized mechanism 172, rigid connectors 173 and 174. The shaft 171 comprises a horizontal axis. The connector 173 is configured to rigidly connect the shaft 171 and the component 149, or the component 173 which is rigidly connected to the component 149. The motorized mechanism 172 comprises a base component which is rigidly connected to the ground by the rigid connector 174. The motorized mechanism 172 is connected to the shaft 171 and is configured to produce a back-and-forth motion between two end-positions in the shaft 171 around the axis of the shaft.

Since the shaft 171 is rigidly connected to the support component 149 of the stirring mechanism, the motorized mechanism 172 produces a back-and-forth rotation in the support component 149. At a first end-position of the support component 149 in the back-and-forth rotation, the axis of the first rotational mechanism (comprising mating parts 133 and 134) is configured to be vertical, and the cookware 11 is configured to be at the upright position. At the second end-position of the support component 149 in the back-and-forth rotation, the cookware 11 is turned at an angle as to dispense a cooked food held in the cookware 11. The angular degree between the first end-position and the second end-position is usually between 90 degrees and 180 degrees.

A motion mechanism may comprise the motorized mechanism 172, the shaft 171 and its connection to the stirring mechanism 102. Said motion mechanism is also referred to as an unloading mechanism and is configured to move the stirring mechanism 102 and thus indirectly move the cookware 11 as to dispense a cooked food from the cookware. It should be noted that said unloading mechanism may be substituted by a motion mechanism configured to move the cookware 11 directly.

It should be noted that the cooking apparatus 103 comprises a motion apparatus comprising: a motion mechanism comprising the stirring mechanism 102 and its connection to the cookware 11, said motion mechanism is configured to produce a motion in the cookware as to stir or mix food or food ingredients contained or otherwise held in the cookware; and an unloading mechanism comprising the motorized mechanism 172, the shaft 171 and its connection to the stirring mechanism 102, said unloading mechanism is configured to produce a motion in the cookware 11 as to dispense a cooked food from the cookware.

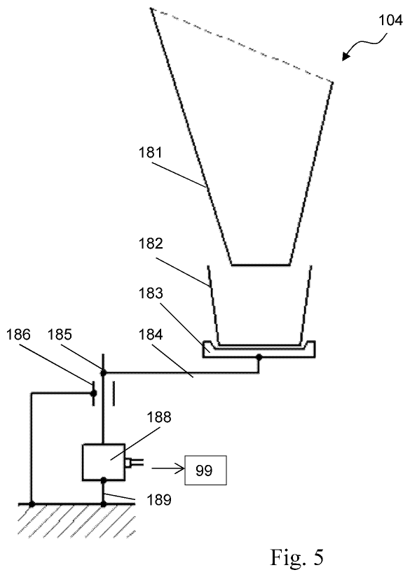

Referring to FIG. 5, a receiving mechanism 104 comprises: a funnel 181; a food container 182; a holder 183; a rotational mechanism comprising mating parts 185 and 186, wherein the part 185 is a shaft and the axis of the rotational mechanism is the axis of the shaft; rigid connectors 184 and 189; a motorized mechanism 188. The funnel 181 may be fixedly connected to the ground (although the connection is not shown in figures). The food container may be positioned on the holder 183 and is configured to contain or otherwise hold a cooked food. The motorized mechanism 188 comprises a base component which is connected to the ground by the rigid connector 189. The motorized mechanism 188 is configured to produce a back and forth rotation in the shaft 185 around the axis of the shaft 185. The axis of the shaft 185 is configured to be vertical, and the holder 183 and the food container 182 may be rotated around the (vertical) axis of the shaft 185. The rigid connector 184 is configured to rigidly connect the holder 183 and the shaft 185. Thus, the motorized mechanism 188 produces a back-and-forth rotation in the holder 183, between two end-positions. Since a rotation around a vertical axis is always a planar motion, a food container 182 placed on the holder 183 may be moved in a planar motion, as the holder 183 is moved. At a first end-position of the holder 183 in the back-and-forth motion, the food container 182 on the holder 183 is positioned right below the funnel 181 as to receive a cooked food which is dispensed into the funnel from above.

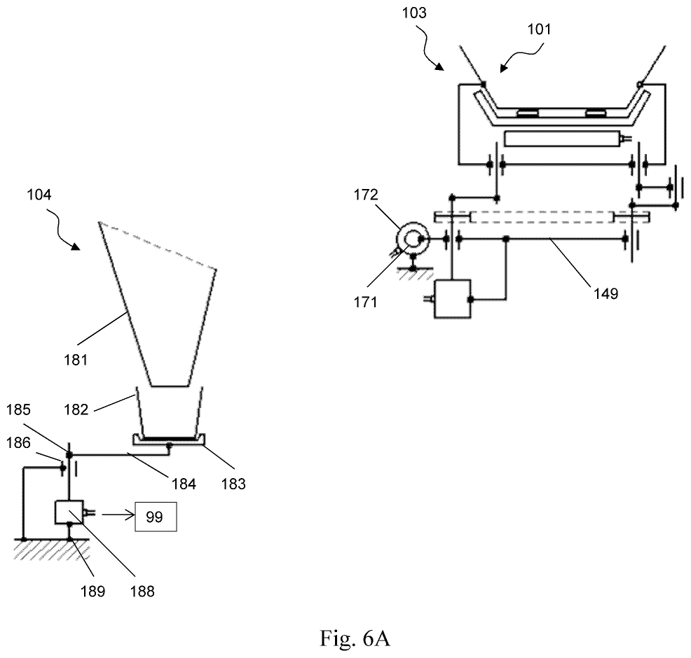

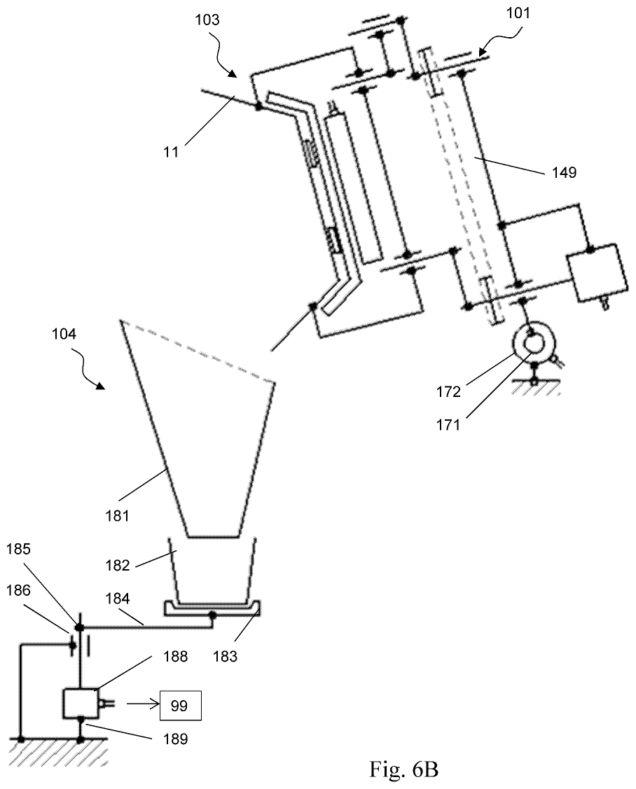

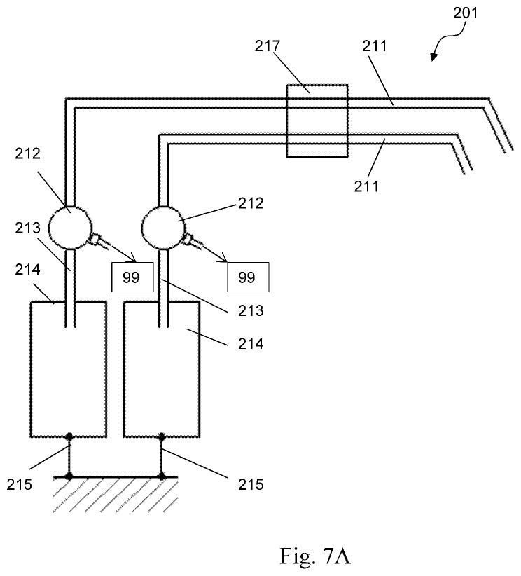

Referring to FIGS. 6A-6B, when the support component 149 of the cooking apparatus 101 in the cooking apparatus 103 is moved to the second end-position from the first end-position, a cooked food held in the cookware 11 may be dispensed into the funnel 181, and dispensed into a food container 182 which is on the holder 183 (see FIG. 6B). Prior to this motion, the holder 183 in the receiving mechanism 104 is moved to the first end-position.

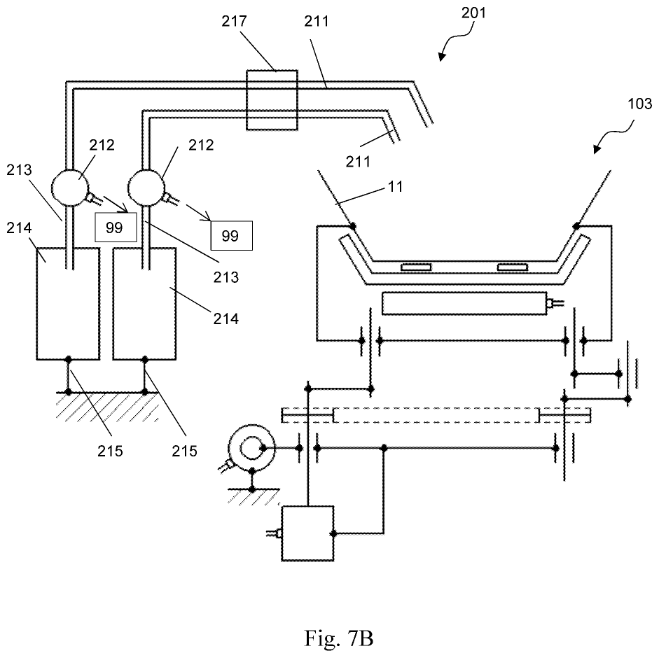

Referring to FIG. 7A, a liquid dispensing mechanism 201 comprises: a first liquid dispensing mechanism comprising: a plurality of liquid pipes 211; a plurality of liquid pipes 213, a plurality of liquid pumps 212; a plurality of liquid containers 214; a plurality of connectors 215; a connector 217. (An end of each pipe 211 is to be positioned above a cookware so that a liquid flowing in the pipe may be dispensed into the cookware.) Each liquid container 214 is configured to hold a liquid, e.g., cooking oil, vinegar, or water. Each liquid container 214 is configured to be connected to the ground by a connector 215. Each pump 212 is connected to a pair of corresponding pipes 211 and 213; and said pipe 213 is configured to be inserted into a corresponding liquid container 214, so that the pump can draw liquid from the liquid container. Each pump 212 is configured to be connected to the computer system 99, so that the computer system may control the timing and amount of liquid to be drawn from the corresponding liquid container. The connector 217 is configured to fixedly connect the pipes 211 to improve rigidity or stability of the pipes.

Referring to FIG. 7B, the liquid dispensing mechanism 201 is used to dispense a plurality of liquid ingredients into the cookware 11 of a cooking apparatus 103. An end of each pipe 211 is to be positioned above the cookware 11 of the cooking apparatus 103, so that a liquid may be dispensed from the liquid containers 214 into the cookware 11.

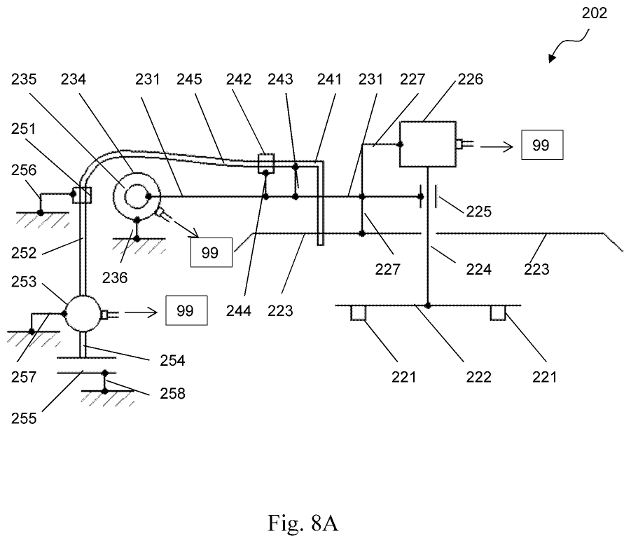

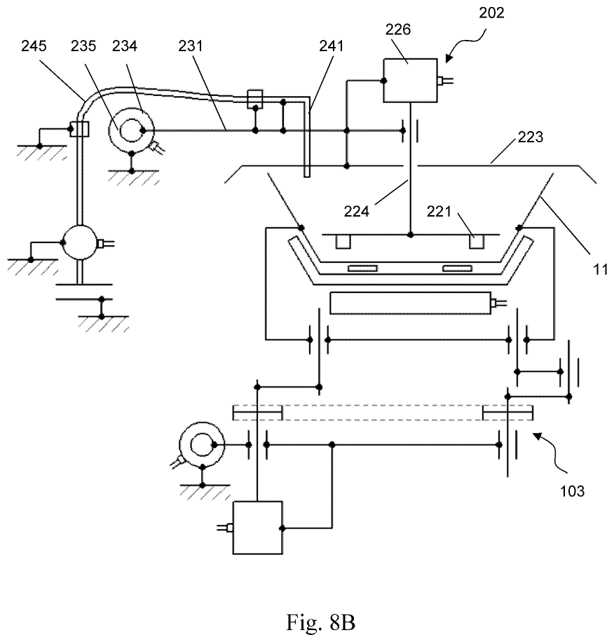

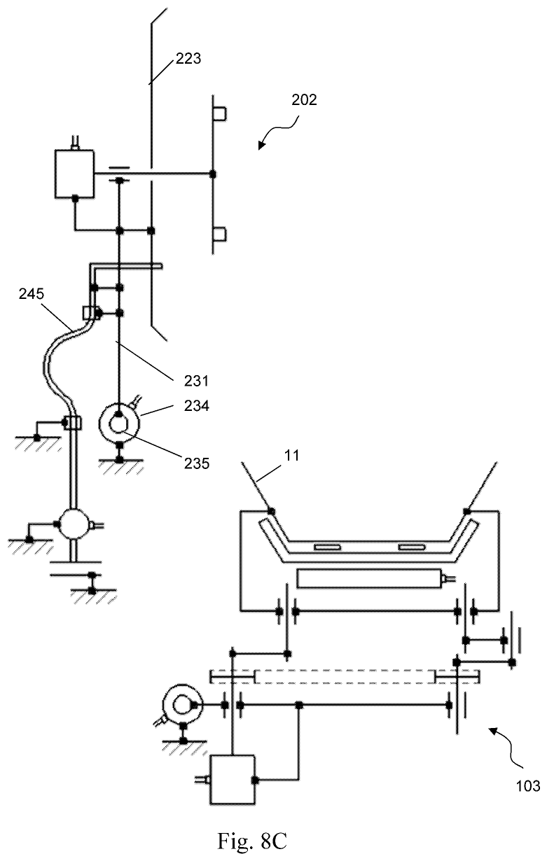

Referring to FIG. 8A, a cookware cleaning mechanism 202 comprises: a plurality of blades 221; a board 222; a cover 223; a rotational mechanism comprising mating parts 224 and 225, wherein the part 224 is a shaft and the axis of the rotational mechanism is the axis of the shaft; and a motorized mechanism 226. The motorized mechanism 226 is configured to produce rotation in the shaft 224 around the axis of the shaft 224. The board 222 is configured to be rigidly connected to the blades 221 and to the shaft 224. Thus, the motorized mechanism 226 produces a rotation in blades 221 around the axis of the shaft 224. The motorized mechanism 226 is connected to the computer system 99 via wires, so that the computer system 99 may control the timing and speed of the motorized mechanism 226.

The cookware cleaning mechanism 202 further comprises: a support component 231; a shaft 235; a motorized mechanism 234; a rigid connector 236. The shaft 235 comprises a horizontal axis. The support component 231 is configured to be rigidly connected to the shaft 235 and to the mating part 225. The motorized mechanism 234 comprises a base component which is rigidly connected to the ground by the rigid connector 236. The motorized mechanism 234 is configured to produce a back-and-forth motion between two end-positions in the shaft 235 around the axis of the shaft. The axis of the shaft 235 is configured to be horizontal, and perpendicular to the axis of the shaft 224. Since the shaft 235 is rigidly connected to the support component 231, the motorized mechanism 235 produces a back-and-forth rotation in the support component 231 between two end-positions (relative to the ground). The motorized mechanism 234 is connected to the computer system 99 via wires, so that the computer system 99 may control the timing and speed of the motorized mechanism 234.

The motorized mechanism 226 comprises a base component which is fixedly connected to the support component 231 and to the cover 223 by a rigid connector 227. The cover 223 and the board 222 are both configured to be rotationally symmetric around the axis of the shaft 224.

The cookware cleaning mechanism 202 further comprises: (inflexible) pipes 241, 252 and 254; a flexible pipe 245; pipe connectors 242 and 251; connectors 243 and 244; a liquid pump 253; a liquid source pipe 255; connectors 256, 257 and 258. The pipe 241 is connected to the pipe 245 by the pipe connector 242; and the other end of the pipe 241 is open. The pipe 245 is connected to the pipe 252 by the pipe connector 251. The liquid pump 253 is connected to the pipes 252 and 254. The pipe 254 is connected to a liquid source pipe 255. The connector 243 is configured to fixedly connect the support component 231 and the pipe 241. The connector 244 is configured to fixedly connect the support component 231 and the pipe connector 242. The liquid pump 253 is configured to draw liquid from the liquid source pipe 255 and flow liquid from the liquid source pipe to the open end of the pipe 241. The pipe connector 251, the liquid source pipe 255, and a base component of the liquid pump 253 are configured to be fixedly connected the ground respectively by the connectors 256, 257 and 258. The liquid pump 253 is connected to the computer system 99, so that the computer system may control the timing and amount of liquid to be drawn from the liquid source pipe.

Referring to FIGS. 8B-8C shows the relative positions of the above cookware cleaning mechanism 202 and the cookware 11 of a cooking apparatus 103. At a first end-position of the support component 231 (in the back-and-forth rotation produced by the motorized mechanism 234), the axis of the rotational mechanism (which comprises the mating parts 224 and 225) is configured to be vertical and the open end of the pipe 241 is to be positioned above the cookware 11 when the cookware is at the upright position (see FIG. 8B), so that liquid may be flown into the cookware. The liquid may be used to clean the cookware.

The motorized mechanism 226 is configured to drive a one-way rotation of the blade 221 to wash the inner surface of the cookware, while the cover 223 seals the cookware. Liquid may be partially trapped by the board 222, while the rotating blades are configured to pressure the liquid to flow towards the axis of the shaft 224, hence toward the center of the cookware, thus build a pressure in the liquid therein.

When the support component 231 is rotated to the second end-position, the components 221, 222, 223, 224, 225, 226 and 227 are all rotated by an angle, away from the cookware. The angular degree between the first end-position and the second end-position may be about 90 degrees, although this is not a strict requirement.

The liquid in the liquid source pipe 255 may comprise hot water or other liquid suitable for cleaning a cookware.

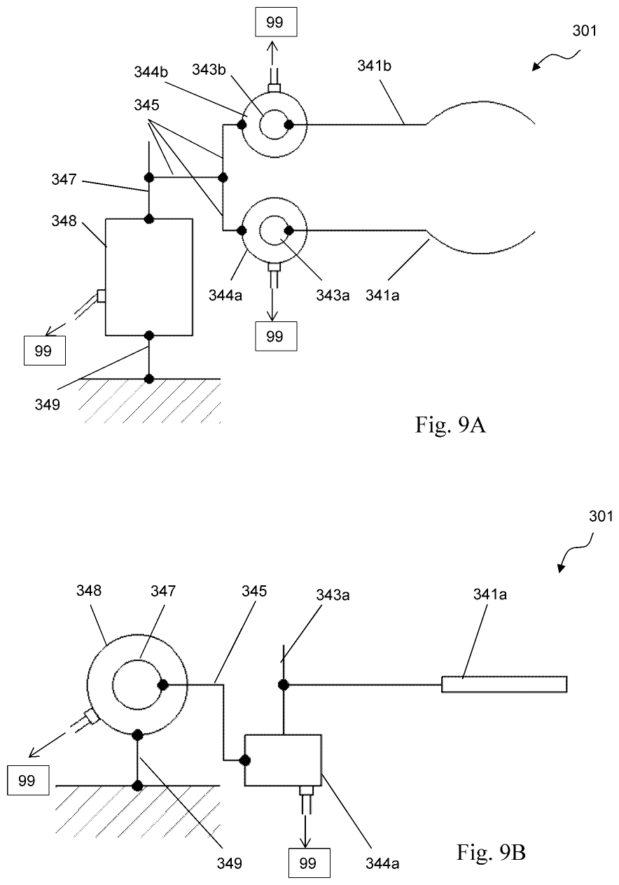

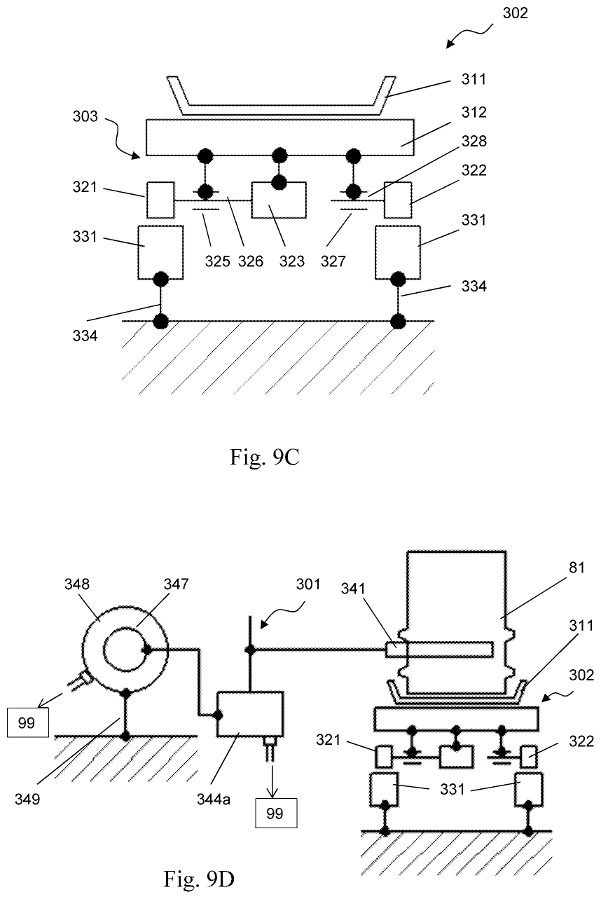

Referring to FIGS. 9A-9B, a dispensing mechanism 301 comprises: a support component 345; gripping devices 341a and 341b; shafts 343a and 343b; motorized mechanisms 344a and 344b. The motorized mechanism 344a or 344b comprises a base component which is rigidly connected to the support component 345. The gripping device 341a is rigidly connected to the shaft 343a. The motorized mechanism 344a is configured to produce a rotation in the shaft 343a around the axis of the shaft relative to the support component 345. Similarly, the gripping device 341b is rigidly connected to the shaft 343b. The motorized mechanism 344b is configured to produce a rotation in the shaft 343b around the axis of the shaft relative to the support component 345. As the gripping device 341a or 341b is rigidly connected to the shaft 343a or respectively 343b, the motorized mechanism 344a or 344b produces a rotation in the gripping device 341a or respectively 341b. The shafts 343a and 343b are configured to have parallel axes, and the motorized mechanisms 344a and 344b are configured to rotate the respective gripping devices 341a and 341b in opposite directions simultaneously. In fact, the gripping devices 341a and 341b may be configured to rotate anti-synchronously. Each of the gripping devices 341a and 341b are configured to be rotated between two end-positions. At some first end-positions, the gripping devices 341a and 341b are configured to work together to grip a container under the condition that the container is placed in a certain position relative to the support component 345.

The ingredient dispensing mechanism 301 further comprises: a shaft 347; a motorized mechanism 348; a rigid connector 349. The shaft 347 comprises a horizontal axis; and said axis is perpendicular to the axes of the shafts 343a and 343b. The support component 345 of is configured to be rigidly connected to the shaft 347. The motorized mechanism 348 comprises a base component which is rigidly connected to the ground by the rigid connector 349. The motorized mechanism 348 is configured to produce a back-and-forth motion, between two end-positions, in the shaft 347 around the axis of the shaft. The rigid connector 349 is referred to as the support component of the ingredient dispensing mechanism 301.

Since the shaft 347 is rigidly connected to the support component 345, the motorized mechanism 348 produces a back-and-forth rotation in the support component 345 between two end-positions. At a first end-position of support component 345 in the back-and-forth rotation, the axes of the shaft 343a and 343b are configured to be vertical and the gripping devices 341a and 341b, when rotated to their first end-positions relative to the support component 345, are configured to grip a container, in an upright position, which contains food or food ingredients, under the condition that the container is at a certain position relative to the support component 349. Said position of the container is referred to as the dispensing position relative to the support component 349. Then, the support component 345 is rotated to the second end-position while the container is gripped by the gripping devices 341a and 341b, so that the container is turned by an angle as to dispense the food or food ingredients into a cookware or a basket. Virtually entire content of the container are dispensed by the turning of the container. The angular degree between the first end-position and the second end-position in the rotation of the support component 345 is usually between 90 degrees and 180 degrees. The motorized mechanisms 344a, 344b and 348 are connected to the computer system 99 via wires, so that the computer system 99 may control the timing and speed of the motorized mechanisms.

Referring to FIG. 9C, a transport system 302 comprises a track comprising pairs of mini rails 331 and a plurality of mini-vehicles 303. Each mini-vehicle 303 comprises: one or more container holders 311; a support component 312; a first rotational mechanism comprising mating parts 325 and 326; a plurality of second rotational mechanism each comprising mating parts 327 and 328; a driving wheel 321 and a plurality of wheels 322; and a motorized mechanism 323. Each container holder 311 is configured to hold an (uncapped) ingredient container, at an upright position; wherein the ingredient container, in the upright position, is configured to contain food ingredient. Each container holder 311 is rigidly connected to the support component 312. The part 326 is a shaft; and the axis of the first rotational mechanism is the same as the axis of the shaft. The mating part 328 is a shaft; and the axis of each second rotational mechanism is the same as the axis of the shaft 328. The rotational axes of the first rotational mechanism and second rotational mechanism are configured to be horizontal and parallel to each other. The mating part 325 of the first rotational mechanism is rigidly connected to the support component 312 and the mating part 326 of the first rotational mechanism is rigidly connected to the driving wheel 321. The mating part 327 of each second rotational mechanism is rigidly connected to the support component 312 and the mating part 328 of the second rotational mechanism is rigidly connected to a wheel 322. The motorized mechanism 323 comprises a base component which is rigidly connected to the support component 312. The motorized mechanism 323 is configured to produce a rotation in the mating part 326 relative to the mating part 325, hence that the driving wheel 321 is rotated relative to the support component 312.

Each mini rail 331 of the transport system 302 is rigidly connected to the ground by a rigid connector 334. The motorized mechanism drives a rotation of the wheel 321, the mini-vehicle 303 and the container holders 311 on the mini-vehicle 303 are configured to move along the mini rails 331. The transport system 302 is configured to transfer ingredient containers. The motorized mechanism 323 is connected to the computer system 99 via wireless means, so that the computer system 99 may control the timing and speed of the motorized mechanism.

It should be noted that the mini vehicle may comprise other components for the purpose of staying on track.

Referring to FIG. 9D, a mini-vehicle 303 in the transport system 302 may move an ingredient container 81, in the upright position, to a dispensing position relative to the support component 349 of the ingredient dispensing mechanism 301. Then the support component 345 may be rotated to the first end-position relative to the support component 349 while the gripping devices 341a and 341b are kept at their second end-positions, and then, the gripping devices are rotated to their first end-position as to grip the ingredient container 81.

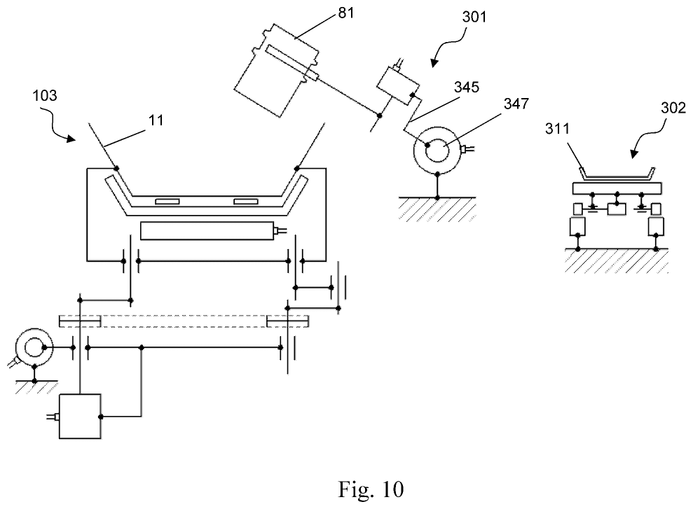

FIG. 10 shows the relative position of the cooking apparatus 103, ingredient dispensing mechanism 301 and the transport system 302. A mini-vehicle 303 of the transport system 302 moves an ingredient container 81, which contains food ingredients, to a dispensing position relative to the support component 349 of the ingredient dispensing mechanism 301. The support component 345 of the ingredient dispensing mechanism 301 may be rotated to the first position, and then the gripping devices 341a and 341b may be moved to their first end-positions as to grip the ingredient container 81. Then the support component 345 is rotated to the second end-position, as to dispense the food ingredients from the ingredient container 81 into the cookware 11 of the cooking apparatus 103. The ingredient dispensing mechanism 301 is configured so that virtually entire content held in the ingredient container 81 is dispensed into the cookware 11; wherein exception (to the “virtually entire content”) may be a very small quantity of ingredients which are undesirably stubbornly sticking to a surface of the container 81 and this small quantity of ingredients will be waste. Afterwards, the support component 345 is rotated back to the first end-position, and after that, the gripping devices 341a and 341b are rotated to their second end-positions, as to let loose the emptied container, as to be placed on the holder 341 of the mini-vehicle 303. It should be noted that the mini-vehicle 303 is configured to be braked during the time of the above procedures.

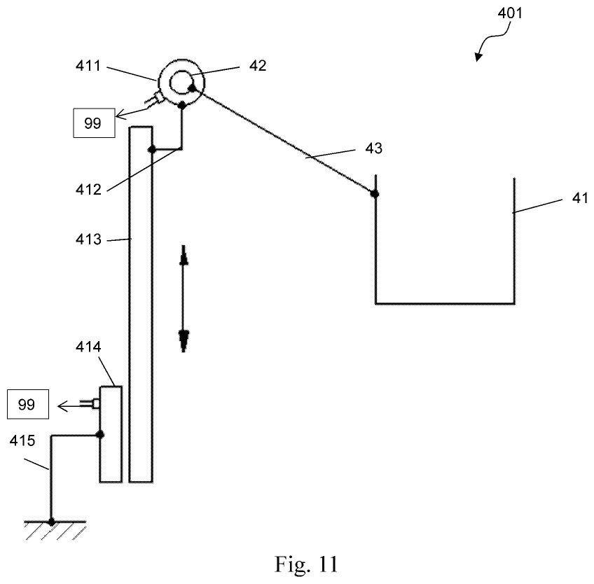

Referring to FIG. 11, a cooking apparatus 401 comprises: a basket 41; a shaft 42; a connector 43; a motorized mechanism 411; a support component 412; a sliding member 413; a motorized mechanism 414; a support component 415. The basket 41, in an upright position, is configured to contain or otherwise hold food or food ingredients. The basket 41 is configured to be porous. The connector 43 fixedly connects the basket 41 and the shaft 42. The motorized mechanism 411 is configured to rotate the shaft 42 and the basket 41, back-and-forth between two end-positions. At the first end-position, the basket is configured to be in the upright position. The motorized mechanism 414 is configured to move the sliding member 413 linearly in the vertical position relative to the support component 415 between two end-positions. A base component of the motorized mechanism 411 is configured to be rigidly connected to the support component 412. The support component 412 is rigidly connected to the sliding component 413. The support component 415 is fixedly connected to the ground. The motorized mechanism 414 produces an up-and-down motion in the support component 412 between two end-positions. The motorized mechanisms 411 and 414 are both connected to the computer system 99, so that the computer may control timings and speeds of their produced motions.

The basket 41 may comprise a metal net.

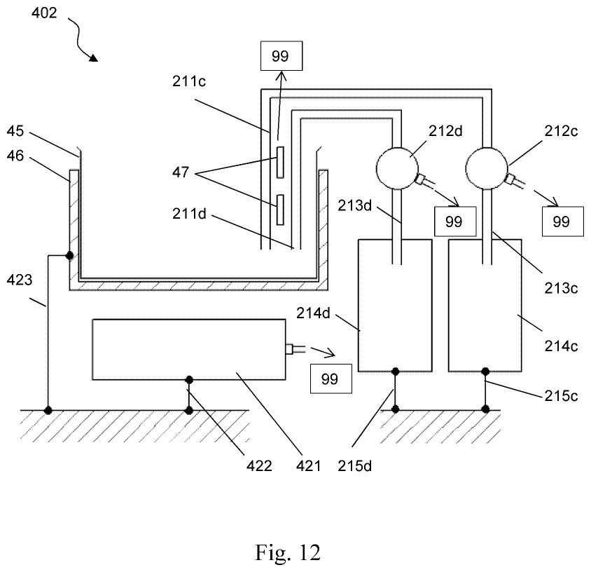

Referring to FIG. 12, a cooking apparatus 402 comprises: a cookware 45; a heat insulation member 46; temperature sensors 47; inductive stove 421; a connector 423; and a connector 422. The heat insulation member 46 is mounted on the exterior of the cookware 45. The connector 423 is configured to connect the insulation member (and hence the cookware 45) to the ground. The connector 422 is configured to connect the inductive stove 421 to the ground. The inductive stove 421 is connected to the computer system 99. The temperature sensors 47 are configured to sense the temperatures of the liquid in the cookware 45. The temperature sensors 47 are configured to be connected to the computer system 99. The cookware 45 is configured to contain a cooking liquid, such as oil or water. The cookware 45 comprises a ferromagnetic metal at a bottom part. The inductive stove 421 is configured to heat the ferromagnetic part of the cookware 45, as to heat the liquid contained in the cookware 45.

The cooking apparatus 402 further comprises: a pair of liquid pipes 211c and 211d; a pair of liquid pipes 213c and 213d, a pair of liquid pumps 212c and 212d; a pair of liquid containers 214c and 214d. An end of the pipe 211c or 211d is inserted into the liquid contained in the cookware 45 of the cooking apparatus 402. The liquid container 214c or 214d is configured to hold a liquid, e.g., cooking oil or water. The container 214c contains fresh liquid; and the container 214d contains waste liquid which will get disposed (disposed in sink if the waste liquid is wastewater). The temperature sensors 47 are mounted on the pipe. The pump 212c (or 212d) is connected to a pair of corresponding pipes 211c and 213c (or respectively 211d and 213d) and an end of said pipe 213c (or respectively, 213d) is configured to be inserted in the liquid contained in the liquid container 214c (or respectively, 214d). The pump 212c is configured to draw fresh liquid from the liquid container 214c and pump it into the cookware 45. The pump 212d is configured to draw (used) liquid from the cookware 45 and pump it into the liquid container 214d. Each pump 212 is configured to be connected to the computer system 99, so that the computer system may control the timing and amount of liquid to be drawn by the pump from the corresponding liquid container.

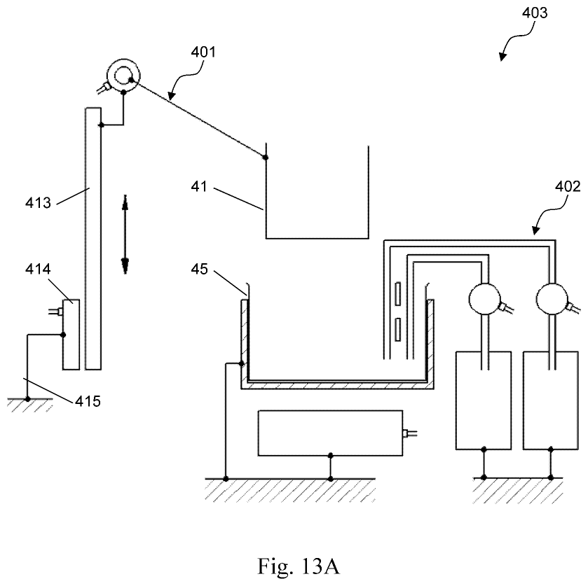

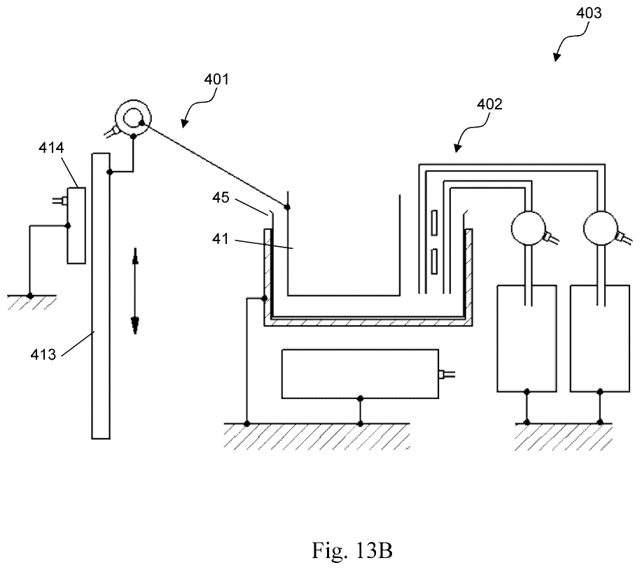

Referring to FIGS. 13A-13B, a cooking apparatus 403 comprises a cooking apparatus 401 and a cooking apparatus 402. When the basket 41 of the apparatus 401 is rotated to the first end-position relative to the sliding member 413, and the sliding member 413 and the support component 412 are moved to the first end-position (i.e., the lower end-position) relative to the support component 415, the basket 41 is configured to be partially immersed in the liquid, as shown in FIG. 13B. When the basket 41 of the apparatus 401 is rotated to the first end-position relative to the sliding member 413, and when the sliding member 413 and the support component 412 are moved to the second end-position (i.e., the upper end-position) relative to the support component 415, the basket 41 is lifted up from the cookware 45, as shown in FIG. 13A. At this time, the motorized mechanism 411 may rotate the basket 41 as to dispense a cooked or semi-cooked food from the basket 41 (also see FIG. 16B later).

It should be noted that the cooking apparatus 403 comprises a motion apparatus comprising: a motion mechanism comprising the motorized mechanism 414, the sliding member 413 and its connection to the basket 41, said motion mechanism configured to produce a motion in the basket as to allow the basket to be partially immersed in the liquid in the container 45 or to be out of the container 45; and an unloading mechanism (which is also a motion mechanism) comprising the motorized mechanism 411, the shaft 42 and its connection to the motorized mechanism 414, said unloading mechanism configured to produce a motion in the basket 41 as to dispense a semi-cooked food from the basket.

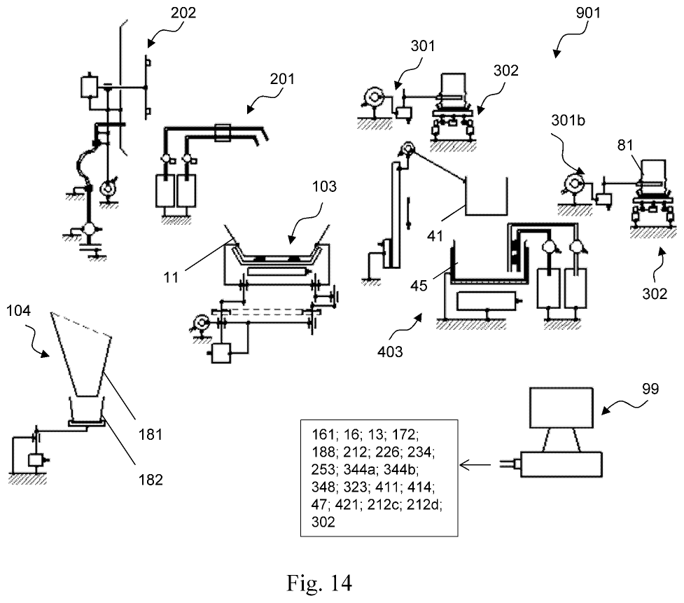

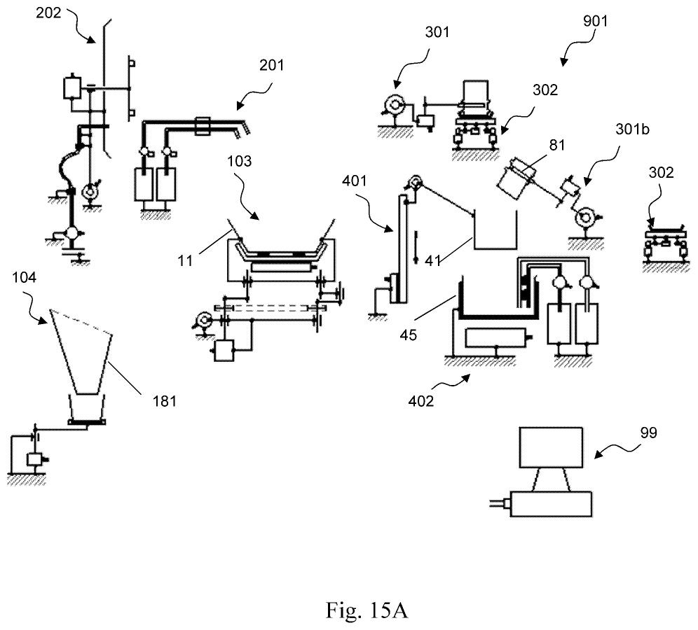

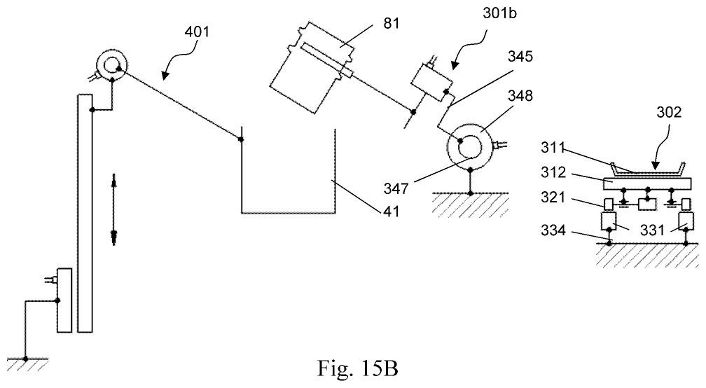

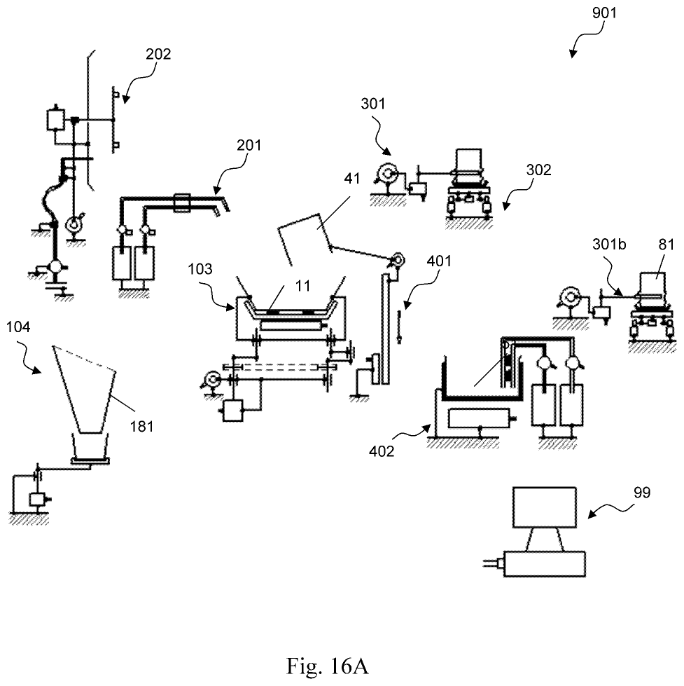

In some embodiments, referring to FIGS. 14-19, a cooking system 901 comprises (from left to right): a receiving apparatus 104; a cookware cleaning mechanism 202; a liquid dispensing mechanism 201; a cooking apparatus 103; a first ingredient dispensing mechanism 301; a transport system 302; a cooking apparatus 403; a second ingredient dispensing mechanism 301b; and a computer system 99. The liquid dispensing mechanism 201 is configured to dispense liquid ingredients into the cookware 11 (as shown in FIG. 7B). The first ingredient dispensing mechanism 301 is positioned next the cooking apparatus 103, as to dispense food ingredients into the cookware 11 of the cooking apparatus 103 (as shown in FIG. 10). The second ingredient dispensing mechanism 301b is a copy of the ingredient dispensing mechanism 301 with the same part numbers but is positioned next the cooking apparatus 403. The part numbers in the mechanism 301b are the same as the corresponding part numbers in the mechanism 301. As shown in FIGS. 15A-15B, the gripping devices of the ingredient dispensing mechanism 301b may be moved to grip an ingredient container 81 containing food ingredients and then rotate the container as to dispense the food ingredients from the container 81 into the basket 41 of the cooking apparatus 401. Meanwhile the basket 41 is at the first end-position relative to the sliding component 413; and the sliding component 413 is at the second end-position relative to the support component 415 (or equivalently, relative to the ground). Then, the sliding component 413 is moved down to the first end-position, so that the basket holding the food ingredients may be immersed in a hot liquid in the cookware 45 of the cooking apparatus 403. The food ingredients in the basked are cooked in the hot liquid, as to produce a semi-cooked food. Then, the sliding component 413 is moved upward to the second end-position and the basket is lifted up and away from the hot liquid in the cookware 45. The basket may be left at this position for another period of time, as to let the hot liquid attached to the semi-cooked food to drip into the cookware 45. Then, as shown in FIGS. 16A-16B, the semi-cooked food contained in the basket 41 may be dispensed into the cookware 11 when the basket 41 is rotated from the first end-position to the second end-position relative to the sliding component 413 which stays at the second end-position. Then the semi-cooked food is further cooked by the cooking apparatus 103, possibly together with other ingredients, some of which are dispensed from an ingredient container on a holder of the transport system 302 by the first ingredient dispensing mechanism 301 (also see FIG. 10). Then a cooked food is produced in the cookware 11. Then, as shown in FIG. 17 (also see FIG. 6B), a cooked food may be dispensed into a food container 182 through the funnel 181.

The cookware cleaning mechanism 202 is positioned next to the cooking apparatus 103 and is configured to clean the cookware 11 (also see FIGS. 8B-8C).

The computer system 99 is configured to be connected to the mechanisms and devices 161. 16, 13, 172, 188, 212, 226, 234, 253, 344a, 344b, 348, 323, 411, 414, 47, 421, 212c and 212d. The computer system 99 is also connected to the transport system 302 as to control the movements of the mini vehicles of the transport system 302.

In cooking system 901, the cooking apparatus 103 is positioned near the following mechanisms and apparatuses: the receiving apparatus 104; the cookware cleaning mechanism 202; the liquid dispensing mechanism 201, the cooking apparatus 403; the ingredient dispensing mechanism 301 which is next to the transport system 302, and the cooking apparatus 403. The cooking apparatus 403 is positioned near the second ingredient dispensing mechanism 301b and the cooking apparatus 103.

The computer system 99 is configured to comprise a memory. The computer system configured to store various data in the computer system's memory.

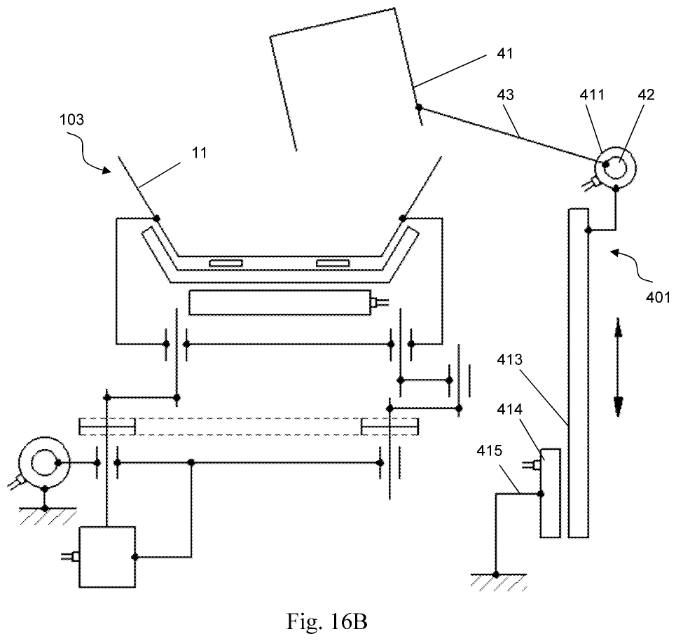

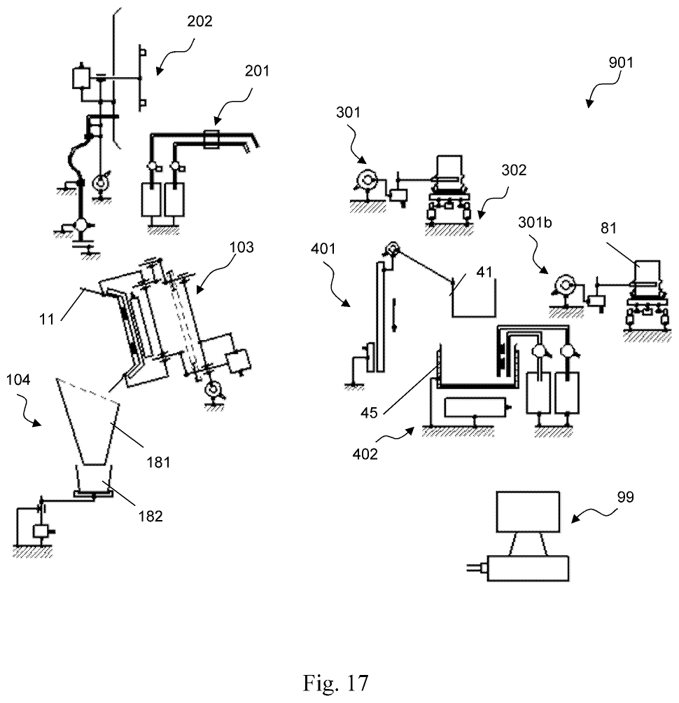

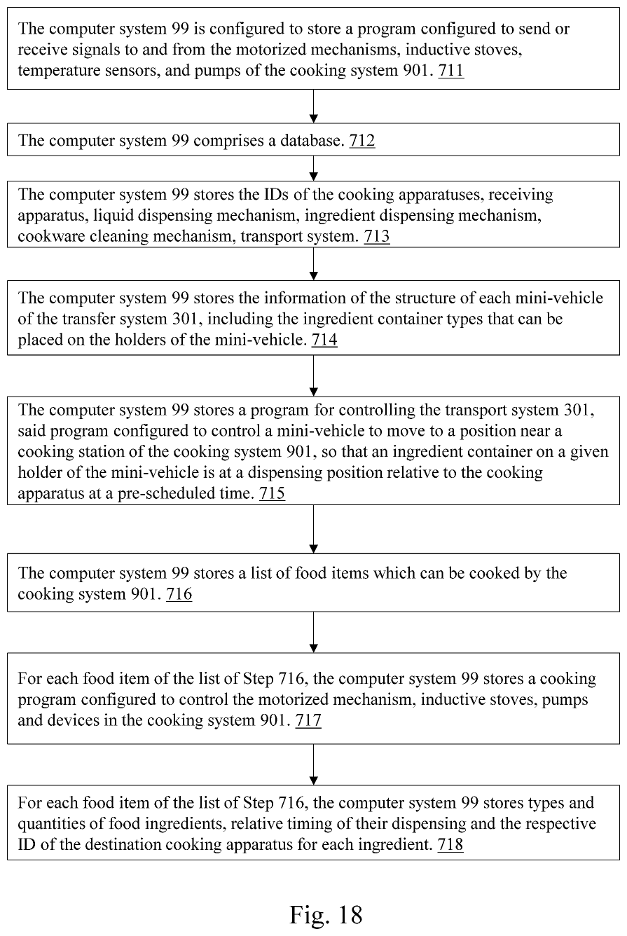

Referring to FIG. 18, the following tasks are performed by the computer system 99 prior to the operation of the cooking system 901.

In Step 711, the computer system 99 stores (in the computer system's memory) a program, configured to send or receive signals to and from the motorized mechanisms, inductive stoves, temperature sensors and pumps of the cooking system 901. The signals are used to control the operations of the motorized mechanisms, inductive stoves and pumps, or to communicate information from the temperature sensors to the computer system 99.

In Step 712, a database is installed in the computer system 99.

In Step 713, each of the cooking apparatuses, receiving apparatus, liquid dispensing mechanisms, ingredient dispensing mechanisms, cookware cleaning mechanism, transport system is assigned a unique ID. The computer system 99 stores the IDs of these apparatuses and mechanisms.

In Step 714, the computer system 99 stores the information of the structure of each mini-vehicle of the transport system 302, including the ingredient container types that can be placed on the holders of the mini-vehicle.

In Step 715, the computer system 99 stores a program for controlling the transport system 302. The program is configured to control a mini-vehicle so the mini-vehicle may move and stop at a pre-scheduled time at a position near a cooking apparatus of the cooking system 901, where a container on a given holder of the mini-vehicle is at a dispensing position relative to the cooking apparatus.

In Step 716, the computer system 99 stores a list of foods which may be cooked by the cooking system 901.

In Step 717, for each food item in the list of Step 716, the computer system 99 stores a cooking program configured to control the motorized mechanism, inductive stoves, pumps and devices in the cooking system 901.

In Step 718, for each food item in the list of Step 716, the computer system 99 stores types and quantities of food ingredients, relative timing of their dispensing and the respective ID of the destination cooking apparatus for each ingredient to be dispensed into; wherein the relative timing refers to the timing relative to the timing of the program of Step 717 corresponding to the food. Food ingredients contained in a container is to be dispensed into a basked or cookware in the destination cooking apparatus.

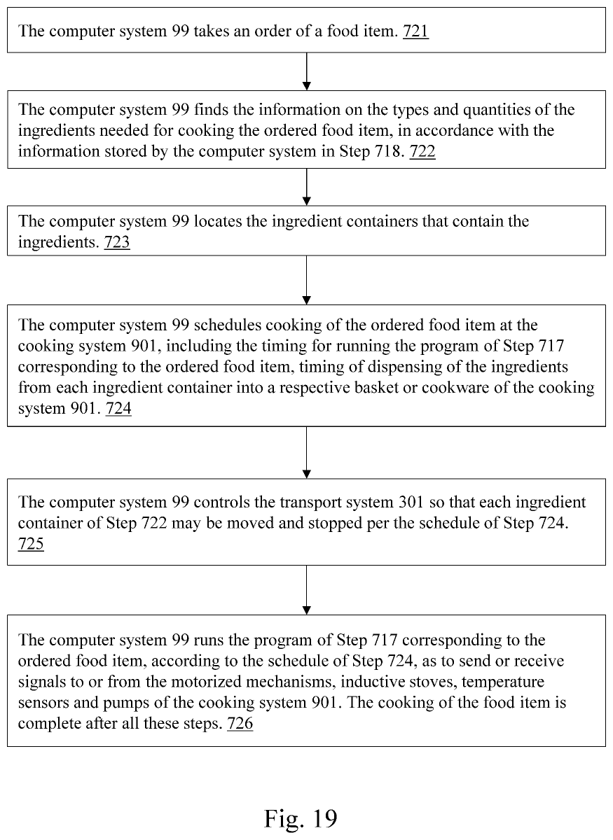

Referring to FIG. 19, the following tasks are routinely performed by the computer system 99 during the operation of the cooking system 901.

In Step 721, the computer system 99 takes an order of a food. The order may be placed by a human either at the computer system 99, or at a computer which sends the order to the computer system 99.

In Step 722, for the ordered food of Step 721, the computer system 99 finds the information on the types and quantities of the ingredients needed for cooking the ordered food. Such information was stored by the computer system 99 in Step 718.

In Step 723, the computer system 99 locates the ingredient containers that contain the food ingredients found in Step 722. The ingredients may be dispensed from some larger containers into said ingredient containers. Alternatively, ingredients may already be in the ingredient containers, and their locations had been stored in the memories of the computer system 99.

In Step 724, the computer system 99 schedules the cooking of the ordered food at cooking system 901. The schedule includes the timing for running the program of Step 717 corresponding to the ordered food. The schedule also includes the timing of dispensing of the ingredients from each ingredient container into a respective basket or cookware of the cooking system 901, in accordance to the stored information by the computer system 99 in Step 718.

In Step 725, the computer system 99 controls the transport system 302 so that each ingredient container of Step 722 may be moved and stopped per the schedule of Step 724.

In Step 726, The computer system 99 runs the program of Step 717 corresponding to the ordered food, according to the schedule of Step 724, as to send or receive signals to or from the motorized mechanisms, inductive stoves, temperature sensors and pumps of the cooking system 901.

After all these steps, the cooking of the food, including dispensing of the cooked food to a food container, is complete.

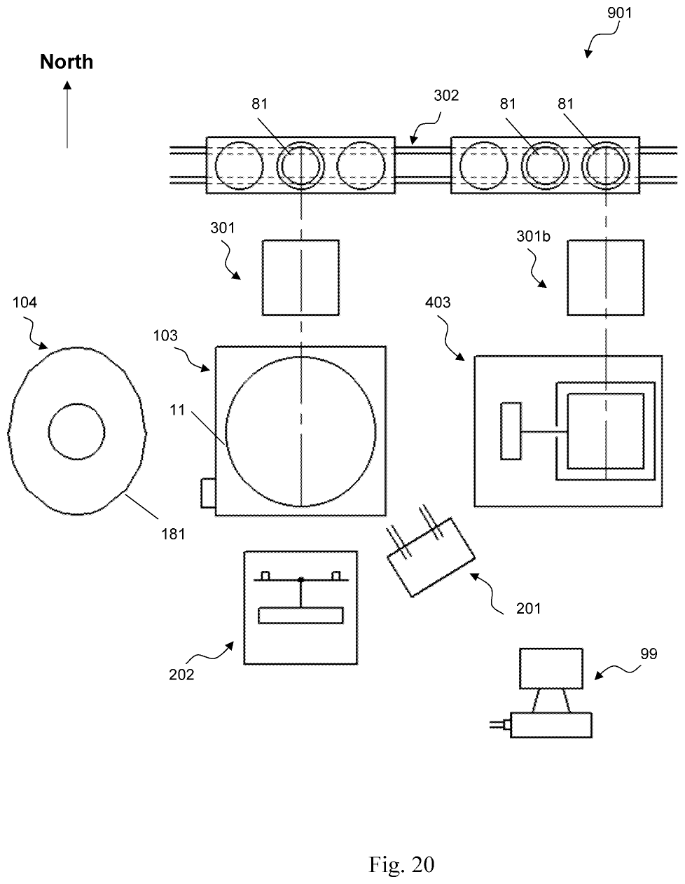

It should be noted that the 3-dimensional positioning of the mechanisms and apparatuses in the cooking system 901 can be done in various ways. For example, the receiving apparatus 104, the cookware cleaning mechanism 202, the ingredient dispensing mechanism 301 and the cooking apparatus 403 may be respectively positioned on the Western, Southern, Northern and Eastern sides of the cookware 11 of the cooking apparatus 103; and the liquid dispensing mechanism 201 may be positioned in the Southeastern side of the cookware 11. The second ingredient dispensing mechanism 301b may be positioned on the Northern side of the cooking apparatus 403. See FIG. 20.

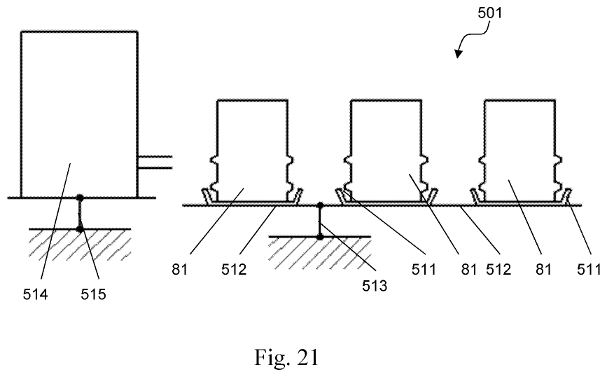

Referring to FIG. 21, a storage apparatus 501 comprises: a plurality of container holders 511; and a support component 512; wherein each container holder 511 is configured to hold one or more ingredient containers 81. Each container holder 511 is configured to be fixedly connected to the support component 512. The support component 512 is rigidly connected to the ground by a rigid connector 513. The storage apparatus 501 also comprises a refrigeration mechanism 514 configured to refrigerate the ingredient containers 81 as to keep the food ingredient in the containers fresh. The refrigeration mechanism 514 is fixedly connected to the ground by a rigid connector 515.

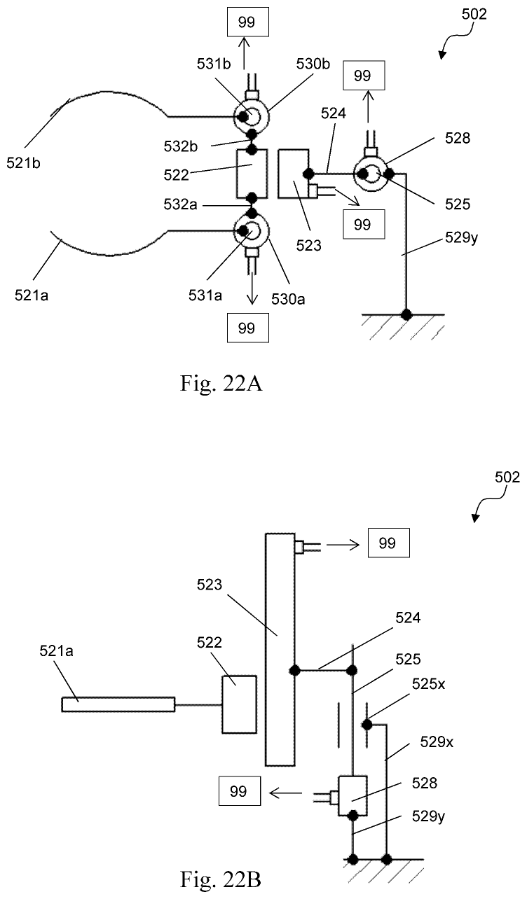

Referring to FIGS. 22A-22B, a loading mechanism 502 comprises: gripping devices 521a and 521b; a shaft 531a rigidly connected to the gripping device 521a; a shaft 531b rigidly connected to the gripping device 521b; a motorized mechanism 530a configured to produce a rotation in the shaft 531a around a vertical axis (which is the same as the axis of the shaft), wherein the motorized mechanism 530a is connected to the computer 99 by wires, wherein the computer system 99 is configured to control the motorized mechanism 530a; a motorized mechanism 530b configured to produce a rotation in the shaft 531b around a vertical axis (which is the same as the axis of the shaft), wherein the motorized mechanism 530b is connected to the computer 99 by wires, wherein the computer system 99 is configured to control the motorized mechanism 530b. The (base components of the) motorized mechanism 530a or 530b are rigidly connected to a slider 522 by connectors 532a or respectively 532b. The motorized mechanism 530a and 530b are configured to produce anti-synchronous rotations in the gripping device 521a and respectively 521b. The gripping devices 521a and 521b are configured to be rotated between some end-positions. At a first end-positions, the gripping devices 521a and 521b are configured to work together to grip a container under the condition that the container is placed in a certain position relative to the slider 522. At the second end-position, the gripped container are configured to be let free from the gripping devices.

The loading mechanism 502 further comprises a vertical motion mechanism 523 configured to produce a back-and-forth vertical linear motion in the slider 522 between a lower end-position and an upper end-position. The vertical motion mechanism 523 is configured to be connected to the computer system 99, wherein the computer system 99 is configured to control the motion of the slider 522. The loading mechanism 502 further comprises: a shaft 525 which is connected to (a base component of) the vertical motion mechanism 523 by a rigid connector 524; a bearing housing 525x and a connection configured to constrain the shaft 525 to rotate around the axis of the shaft, wherein the bearing housing 525x is rigidly connected to the ground by a connector 529x; a motorized mechanism 528 configured to produce a rotation in the shaft 525 around the axis of the shaft 525; a rigid connector 529y configured to connect (a base component of) the motorized mechanism 528 to the ground. The axis of the shaft 525 is vertical. The motorized mechanism 528 is configured to produce a back-and-forth rotation in the shaft 525 and hence in the (base component of the) vertical motion mechanism 523, between two end-positions, around the axis of the shaft 525. It should be noted that the rigid connector 529y may be referred as the support component of the loading mechanism 502.

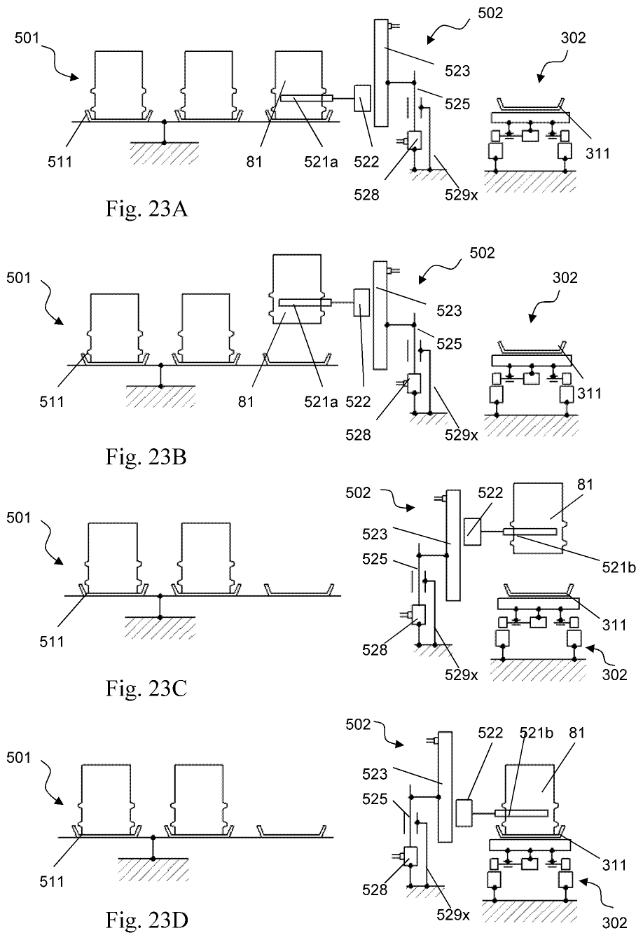

FIGS. 23A-23D show the relative position of the storage apparatus 501, the loading mechanism 502 and the transport system 302. A mini-vehicle 303 of the transport system 302 moves to a certain position relative to the support component 529x of the loading mechanism 502. When the shaft 525 (or the mechanism 523) is at a first end-position of the shaft 525 in the back-and-forth rotation produced by the motorized mechanism 528, and when the slider 522 is at the lower end-position in the vertically linear sliding produced by the mechanism 523, the gripping devices 521a and 521b, when rotated to their first end-positions relative to the slider 522, are configured to grip a container, in an upright position, which contains food or food ingredients, under the condition that the container is at a certain position relative to the support component 529y (see FIG. 23A). Then, the slider 522 is vertically slid to the upper end-position while the container is gripped by the gripping devices 521a and 521b (see FIG. 23B). And then, the shaft 525 and the mechanism 523 are rotated by the motorized mechanism 528 to the second end-position while the container is gripped by the gripping devices 521a and 521b (see FIG. 23C). Then, the slider 522 is vertically slid to the lower end-position, and then the gripping devices 521a and 521b, when rotated to their second end-positions by the motorized mechanism 530a and 530b respectively, are configured to release the container to a container holder 311 of a mini-vehicle 303 (see FIG. 23D). The computer system 99 may control the timing and speed of the motorized mechanisms and the vertical motion mechanism 523. It should be noted that the mini-vehicle 303 is configured to be braked during the time of the above procedures.

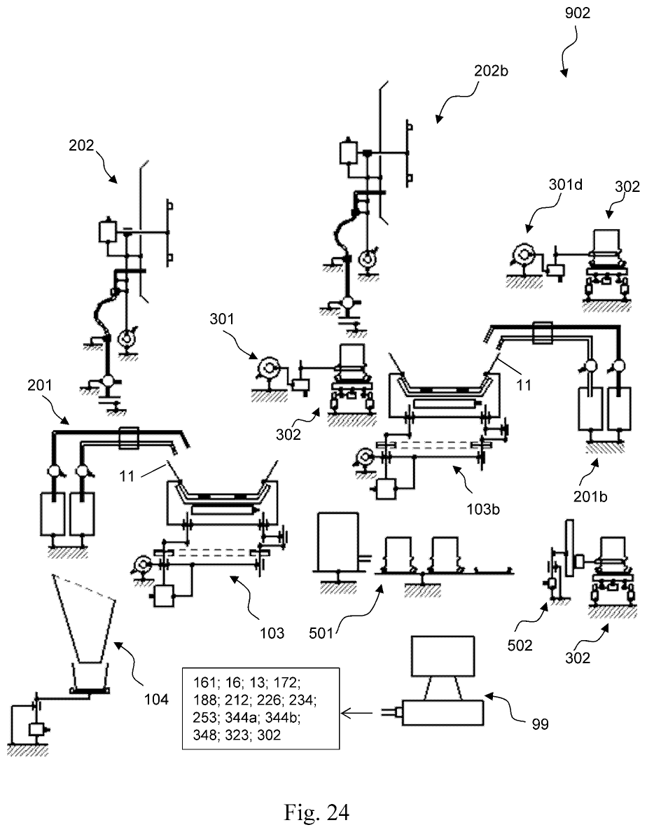

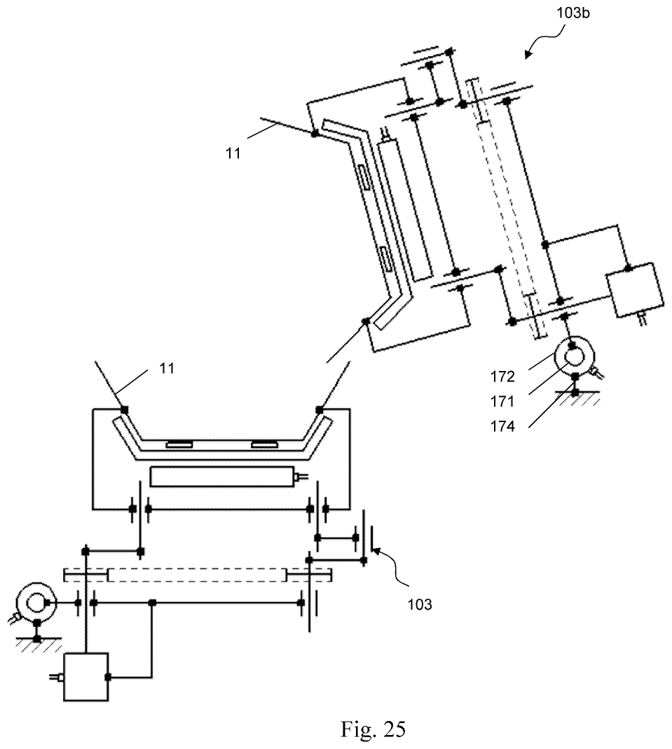

In some embodiments, referring to FIGS. 24-25, a cooking system 902 comprises (from left to right): a receiving apparatus 104; a first liquid dispensing mechanism 201; a first cookware cleaning mechanism 202; a first cooking apparatus 103; a first ingredient dispensing mechanism 301; a transport system 302; a second cookware cleaning mechanism 202b; a second cooking apparatus 103b; a second liquid dispensing mechanism 201b; a second ingredient dispensing mechanism 301d; a storage apparatus 501; a loading mechanism 502; and a computer system 99.

The loading mechanism 502 is configured to load an ingredient container 81 containing food ingredients from the storage apparatus 501 to a mini-vehicle 303 in the transport system 302. The mini-vehicle 303 is configured to move to a location next to the cooking apparatuses as to be gripped by the dispensing mechanism corresponding to the cooking apparatus. The timing of arrival of the mini-vehicle 303 at said location is controlled by the computer system 99.

The first liquid dispensing mechanism 201 is configured to dispense liquid ingredients into the cookware 11 (also shown in FIG. 7B). The second cooking apparatus 103b is a copy of cooking apparatus 103. The part numbers in the cooking apparatus 103b are the same as the corresponding part numbers in the cooking apparatus 103. The second liquid dispensing mechanism 201b is a copy of liquid dispensing mechanism 201 but is positioned next the second cooking apparatus 103b, as to dispense liquid ingredients into the cookware 11 of the cooking apparatus 103b. The part numbers in the mechanism 201b are the same as the corresponding part numbers in the mechanism 201. The first ingredient dispensing mechanism 301 is positioned next the cooking apparatus 103, as to dispense food ingredients from an ingredient container on a holder of the transport system 302 to the cookware 11 (also shown in FIG. 10). The second ingredient dispensing mechanism 301d is a copy of the ingredient dispensing mechanism 301 but is positioned next the cooking apparatus 103b. The part numbers in the mechanism 301d are the same as the corresponding part numbers in the mechanism 301. Similar to the ingredient dispensing mechanism 301 (also shown in FIG. 10), the ingredient dispensing mechanism 301d is configured to dispense food ingredients from an ingredient container on a holder of the transport system 302 to the cookware 11 of the cooking apparatus 103b.

The food ingredients dispensed into the cookware 11 of the cooking apparatus 103b are cooked therein, as to produce a semi-cooked food. Then, the semi-cooked food contained in the cookware 11 of the cooking apparatus 103b is dispensed into the cookware 11 of the cooking apparatus 103, when the cookware 11 of the cooking apparatus 103b is rotated from the first end-position to the second end-position relative to the support component 149 of the cooking apparatus 103b (see FIG. 25). Then the semi-cooked food is further cooked by the cooking apparatus 103, possibly together with other ingredients, some of which are dispensed from an ingredient container on a holder of the transport system 302 by the first ingredient dispensing mechanism 301. Then, a cooked food is produced in the cookware 11 of the cooking apparatus 103. Then, the cooked food is dispensed into a food container 182 in the receiving apparatus 104 (see also FIG. 6B).

The cookware cleaning mechanism 202 is positioned next to the cooking apparatus 103 and is configured to clean the cookware 11 of the cooking apparatus 103 (also see FIGS. 8B-8C). The second cookware cleaning mechanism 202b is a copy of the cookware cleaning mechanism 202; and it is configured to clean the cookware 11 of the cooking apparatus 103b.

The computer system 99 is configured to be connected to the apparatuses, mechanisms and devices 161. 16, 13, 172, 188, 212, 226, 234, 253, 344a, 344b, 348; 323; 501; and 502. The computer system 99 is also connected to the transport system 302 as to control the movements of the mini vehicles of the transport system 302.

In cooking system 902, the cooking apparatus 103 needs to be positioned near the following mechanisms and apparatuses: the receiving apparatus 104; the first cookware cleaning mechanism 202; the liquid dispensing mechanism 201; the ingredient dispensing mechanism 301 which is positioned next to the transport system 302; and the second cooking apparatus 103b. The second cooking apparatus 103b is positioned near the following: the first cooking apparatus 103; the second cookware cleaning mechanism 202b; the second liquid dispensing mechanism 201b; and the second ingredient dispensing mechanism 301d.

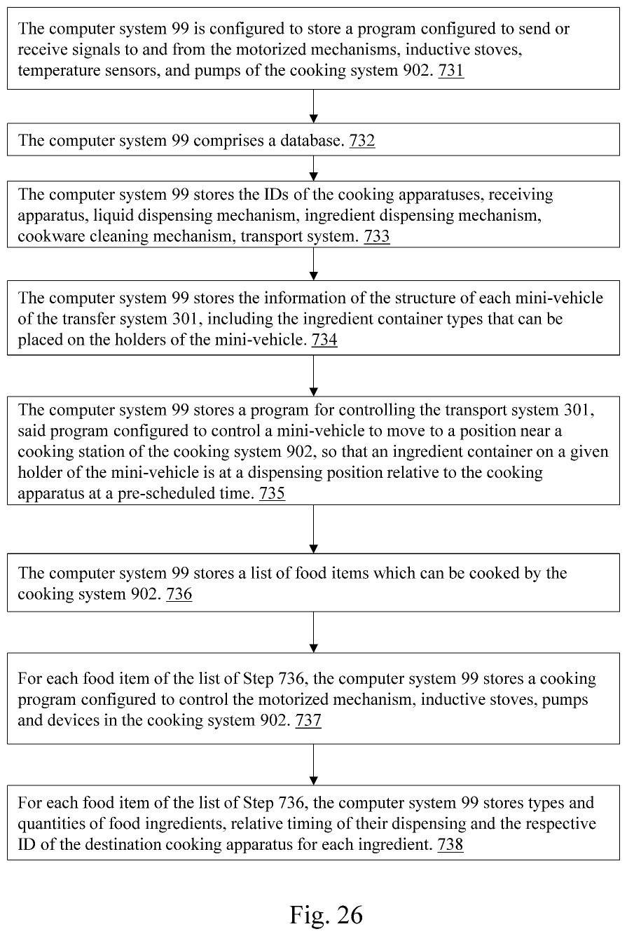

Referring to FIG. 26, the following tasks are performed by the computer system 99 prior to the operation of the cooking system 902.

In Step 731, the computer system 99 stores (in the computer system's memory) a program, configured to send or receive signals to and from the motorized mechanisms, inductive stoves, temperature sensors and pumps of the cooking system 902. The signals are used to control the operations of the motorized mechanisms, inductive stoves and pumps, or to communicate information from the temperature sensors to the computer system 99.

In Step 732, a database is installed in the computer system 99.

In Step 733, each of the cooking apparatuses, receiving apparatus, liquid dispensing mechanisms, ingredient dispensing mechanisms, cookware cleaning mechanisms, transport system is assigned a unique ID. The computer system 99 stores the IDs of these apparatuses and mechanisms.

In Step 734, the computer system 99 stores the information of the structure of each mini-vehicle of the transport system 302, including the ingredient container types that can be placed on the holders of the mini-vehicle.

In Step 735, the computer system 99 stores a program for controlling the transport system 302. The program is configured to control a mini-vehicle so the mini-vehicle may move and stop at a pre-scheduled time at a position near a cooking apparatus of the cooking system 902, where a container on a given holder of the mini-vehicle is at a dispensing position relative to the cooking apparatus.

In Step 736, the computer system 99 stores a list of food items which may be cooked by the cooking system 902.

In Step 737, for each food item in the list of Step 736, the computer system 99 stores a cooking program configured to control the motorized mechanism, inductive stoves, pumps and devices in the cooking system 902.

In Step 738, for each food item in the list of Step 736, the computer system 99 stores types and quantities of food ingredients, relative timing of their dispensing and the respective ID of the destination cooking apparatus for each ingredient to be dispensed into; wherein the relative timing refers to the timing relative to the timing of the program of Step 737 corresponding to the food item. Food ingredients contained in a container is to be dispensed into a basked or cookware in the destination cooking apparatus.

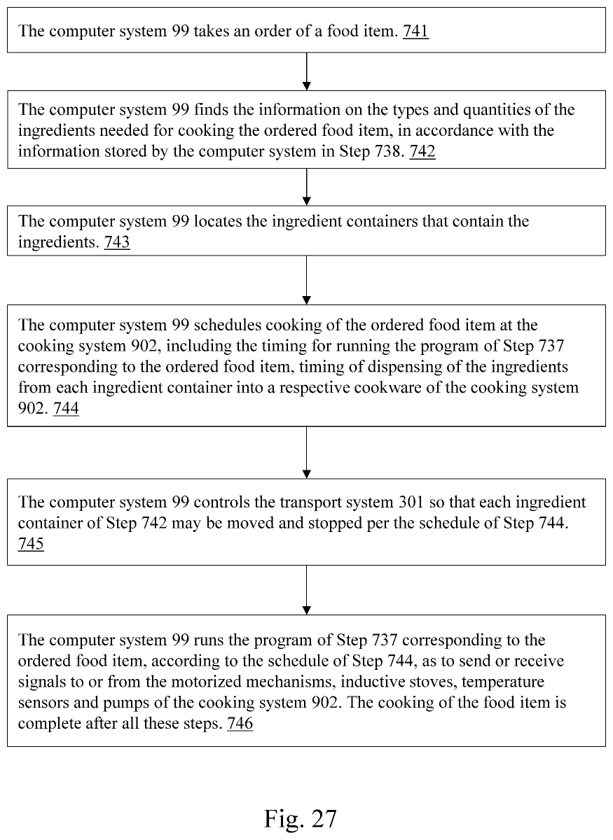

Referring to FIG. 27, the following tasks are routinely performed by the computer system 99 during the operation of the cooking system 902.

In Step 741, the computer system 99 takes an order of a food item. The order may be placed by a human either at the computer system 99, or at a computer which sends the order to the computer system 99.

In Step 742, for the ordered food item of Step 741, the computer system 99 finds the information the types and quantities of the ingredients needed for cooking the ordered food item. Such information was stored by the computer system 99 in Step 738.

In Step 743, the computer system 99 locates the ingredient containers that contain the food ingredients found in Step 742. The ingredients may be dispensed from some larger containers into said ingredient containers. Alternatively, ingredients may already be in the ingredient containers, and their locations had been stored in the memories of the computer system 99.

In Step 744, the computer system 99 schedules the cooking of the ordered food item at cooking system 902. The schedule includes the timing for running the program of Step 737 corresponding to the ordered food item. The schedule also includes the timing of dispensing of the ingredients from each ingredient container into a respective cookware of the cooking system 902, in accordance to the stored information by the computer system 99 in Step 738.

In Step 745, the computer system 99 controls the transport system 302 so that each ingredient container of Step 742 may be moved and stopped per the schedule of Step 744.

In Step 746, The computer system 99 runs the program of Step 737 corresponding to the ordered food item, according to the schedule of Step 744, as to send or receive signals to or from the motorized mechanisms, inductive stoves, temperature sensors and pumps of the cooking system 902.

After all these steps, the cooking of the food item, including dispensing of the cooked food to a food container, is complete.

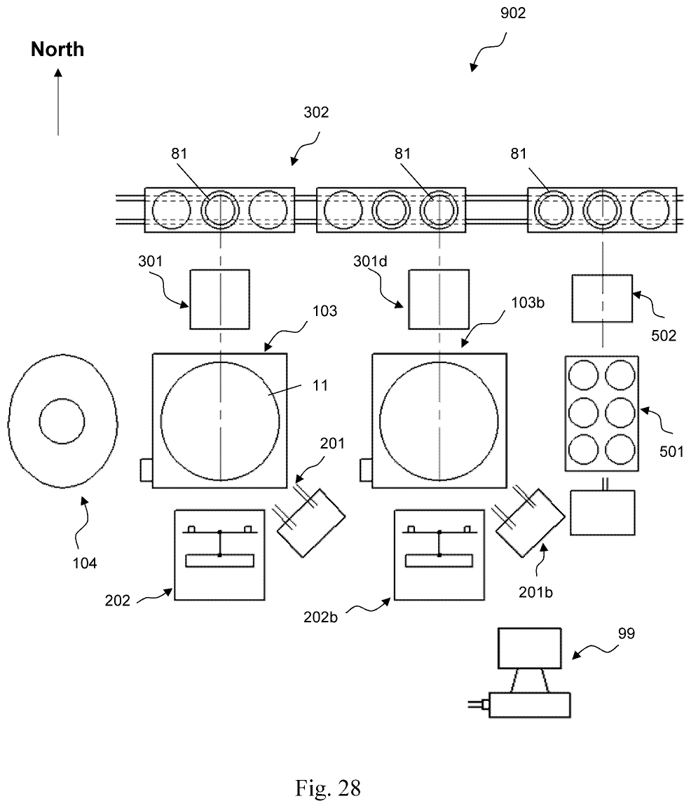

The 3-dimensional positioning of these mechanisms and apparatuses in the cooking system 902 can be done in various ways. For example, the receiving apparatus 104, the cookware cleaning mechanism 202, the ingredient dispensing mechanism 301 and the second cooking apparatus 103b may be respectively positioned on the Western, Southern, Northern and Eastern sides of the cookware 11 of the cooking apparatus 103; and the liquid dispensing mechanism 201 may be positioned in the Southeastern side of the cookware 11. The second cookware cleaning mechanism 202b, the second ingredient dispensing mechanism 301d and the second liquid dispensing mechanism 201b may be positioned on the Southeastern of the cooking apparatus 403. See FIG. 28.

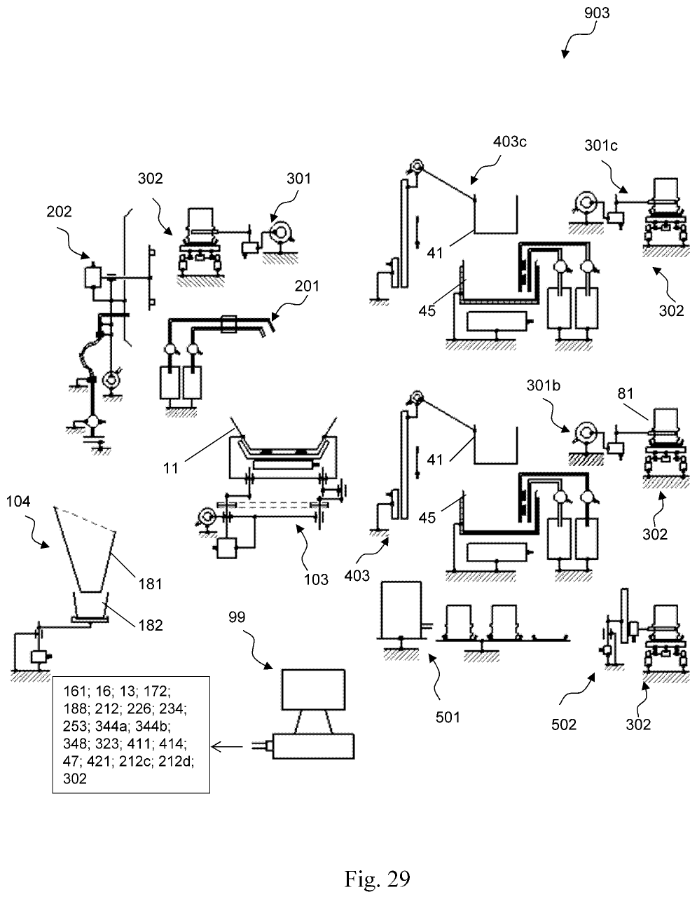

In some embodiments, referring to FIGS. 29-34, a cooking system 903 comprises (from left to right): a receiving apparatus 104; a cookware cleaning mechanism 202; a liquid dispensing mechanism 201; a cooking apparatus 103; a first ingredient dispensing mechanism 301; a transport system 302; a cooking apparatus 403; a cooking apparatus 403c; a second ingredient dispensing mechanism 301b; a third ingredient dispensing mechanism 301c; a storage apparatus 501; a loading mechanism 502; and a computer system 99. The cooking apparatus 403c is a copy of the cooking apparatus 403 with the same part numbers, except that the liquid in the cookware 45 in the cooking apparatus 403c can be different from the liquid in the cookware 45 of the cooking apparatus 403 is cooking oil. The liquid dispensing mechanism 201 is configured to dispense liquid ingredients into the cookware 11 (as shown in FIG. 7B). The first ingredient dispensing mechanism 301 is positioned next the cooking apparatus 103, as to dispense food ingredients into the cookware 11 of the cooking apparatus 103 (as shown in FIG. 10). The second ingredient dispensing mechanism 301b is a copy of the ingredient dispensing mechanism 301 but is positioned next the cooking apparatus 403. The part numbers in the mechanism 301b are the same as the corresponding part numbers in the mechanism 301. The third ingredient dispensing mechanism 301c is a copy of the ingredient dispensing mechanism 301 but is positioned next the cooking apparatus 403c. The part numbers in the mechanism 301c are the same as the corresponding part numbers in the mechanism 301.

The loading mechanism 502 is configured to load an ingredient container 81 containing food ingredients from the storage apparatus 501 to a mini-vehicle 303 in the transport system 302. The mini-vehicle 303 is configured to move to a location next to the cooking apparatuses as to be gripped by the dispensing mechanism corresponding to the cooking apparatus. The timing of arrival of the mini-vehicle 303 at said location is controlled by the computer system 99.

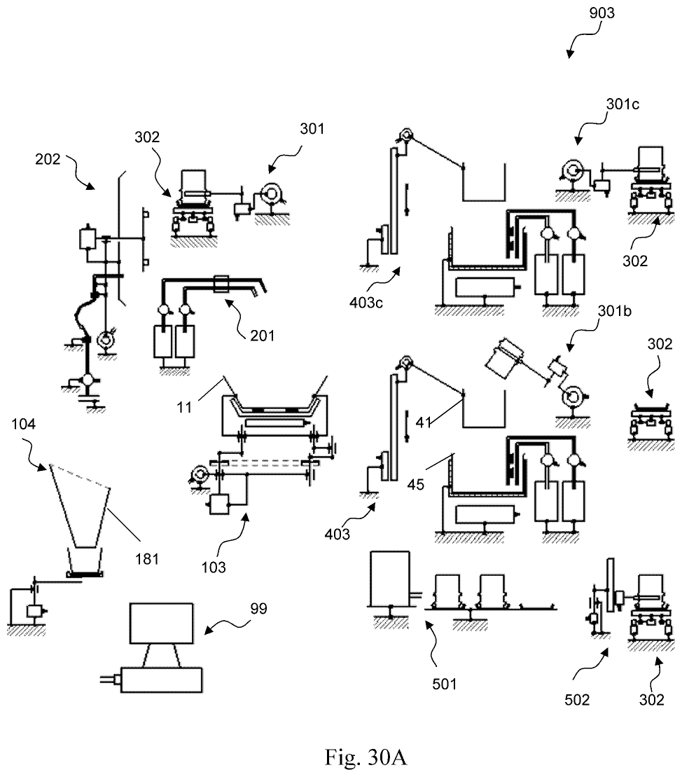

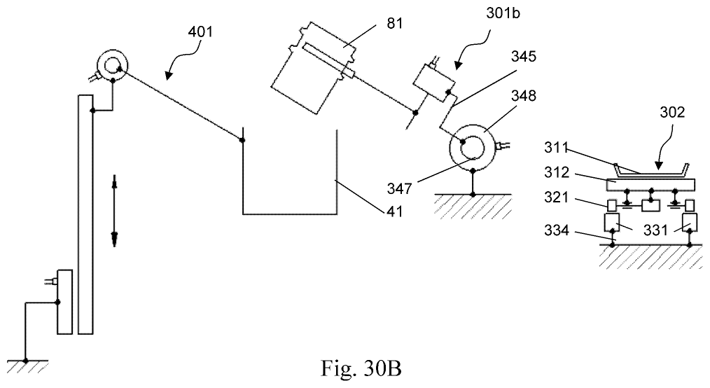

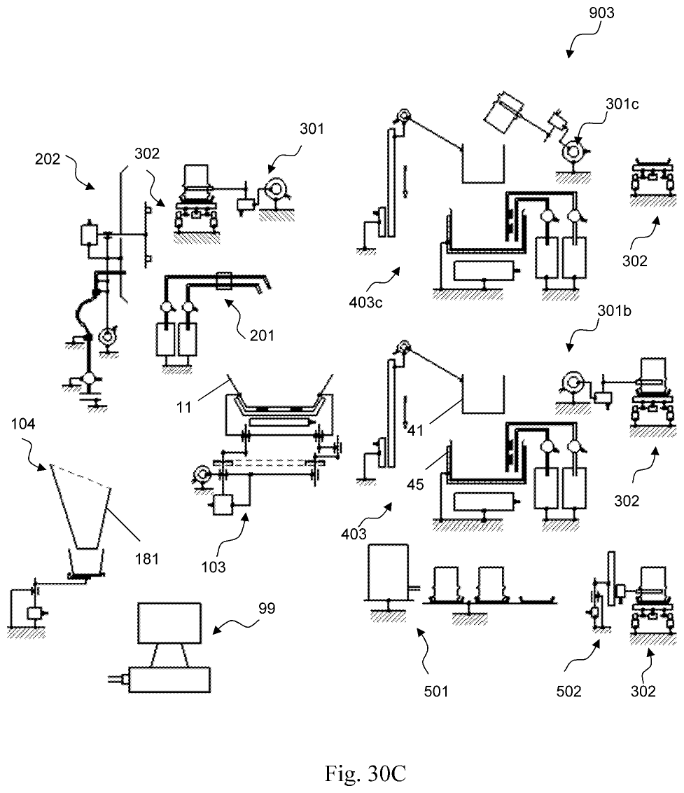

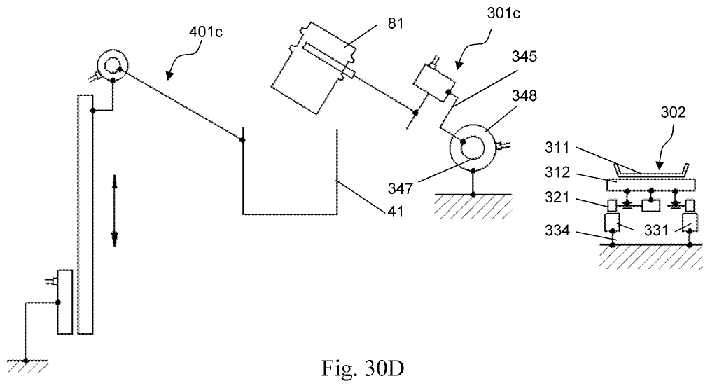

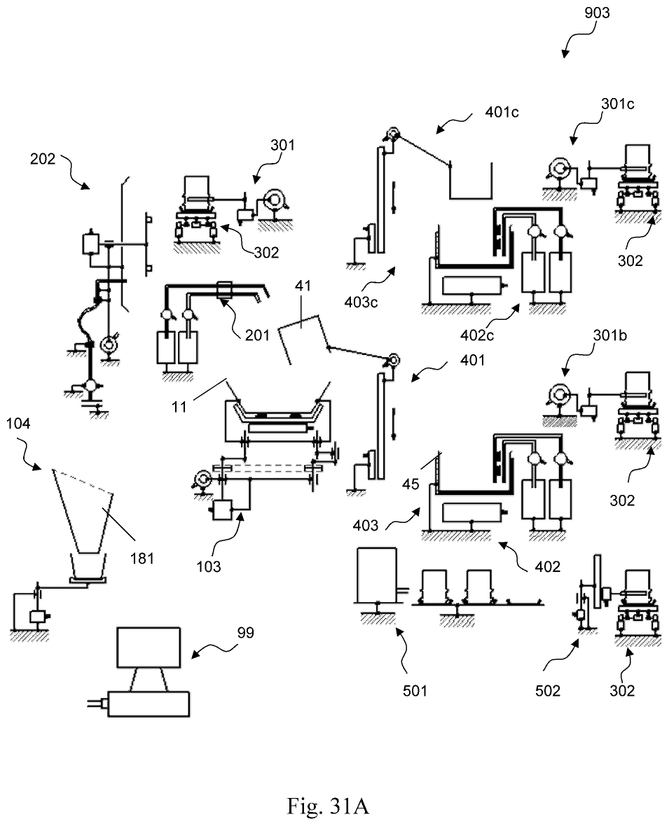

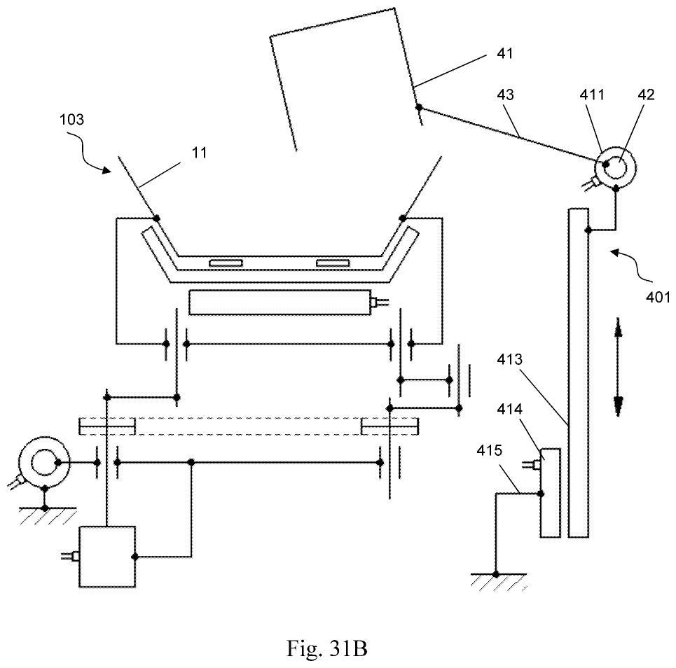

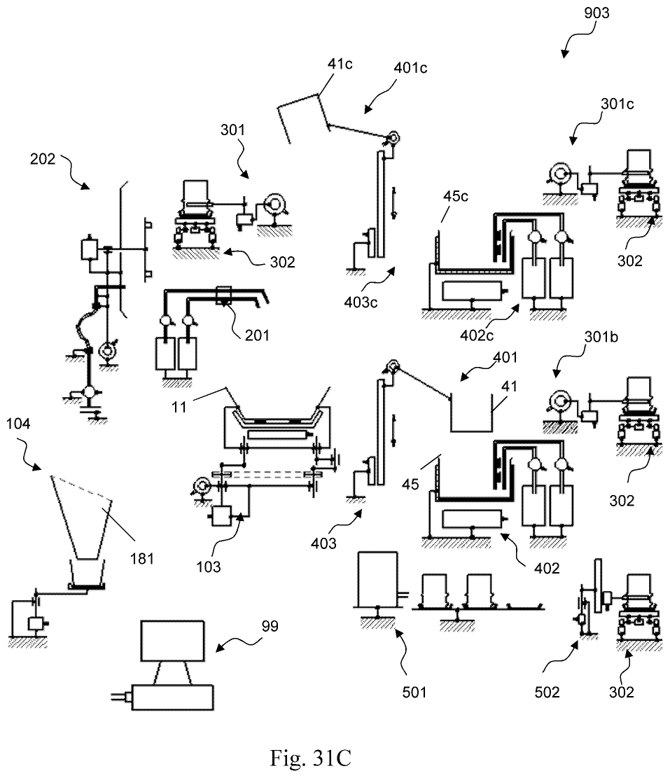

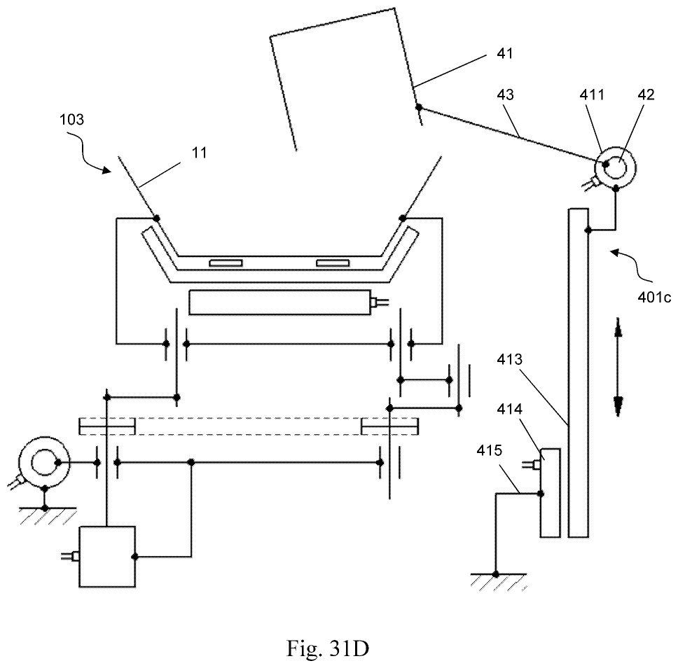

As shown in FIGS. 30A-30B, the gripping devices of the dispensing mechanism 301b may be moved to grip an ingredient container 81 containing food ingredients and then rotate the container as to dispense the food ingredients from the container 81 into the basket 41 of the cooking apparatus 403. Meanwhile the basket 41 of the cooking apparatus 403 is at the first end-position relative to the sliding component 413 of the cooking apparatus 403; and the sliding component 413 is at the second end-position relative to the support component 415 in the cooking apparatus 403 (or equivalently, relative to the ground). Then, the sliding component 413 is moved down to the first end-position, so that the basket holding the food ingredients may be immersed in a hot liquid in the cookware 45 of the cooking apparatus 403. The food ingredients in the basked are cooked in the hot liquid, as to produce a semi-cooked food. Then, the sliding component 413 is moved upward to the second end-position and the basket is lifted up and away from the hot liquid in the cookware 45. The basket may be left at this position for another period of time, as to let the hot liquid attached to the semi-cooked food to drip into the cookware 45. Then, as shown in FIGS. 31A-31B, the semi-cooked food contained in the basket 41 may be dispensed into the cookware 11 of the cooking apparatus 103 when the basket 41 is rotated from the first end-position to the second end-position relative to the sliding component 413 which stays at the second end-position.

Similarly, as shown in FIGS. 30C-30D, the gripping devices of the ingredient dispensing mechanism 301c may be moved to grip an ingredient container 81 containing food ingredients and then rotate the container as to dispense the food ingredients from the container 81 into the basket 41 of the cooking apparatus 403c. Meanwhile the basket 41 of the cooking apparatus 403c is at the first end-position relative to the sliding component 413 of the cooking apparatus 403c; and the sliding component 413 is at the second end-position relative to the support component 415 in the cooking apparatus 403c (or equivalently, relative to the ground). Then, the sliding component 413 is moved down to the first end-position, so that the basket holding the food ingredients may be immersed in a hot liquid in the cookware 45 of the cooking apparatus 403. The food ingredients in the basked are cooked in the hot liquid, as to produce a semi-cooked food. Then, the sliding component 413 is moved upward to the second end-position and the basket is lifted up and away from the hot liquid in the cookware 45. The basket may be left at this position for another period of time, as to let the hot liquid attached to the semi-cooked food to drip into the cookware 45. Then, as shown in FIGS. 31C-31D, the semi-cooked food contained in the basket 41 may be dispensed into the cookware 11 of the cooking apparatus 103 when the basket 41 is rotated from the first end-position to the second end-position relative to the sliding component 413 which stays at the second end-position.

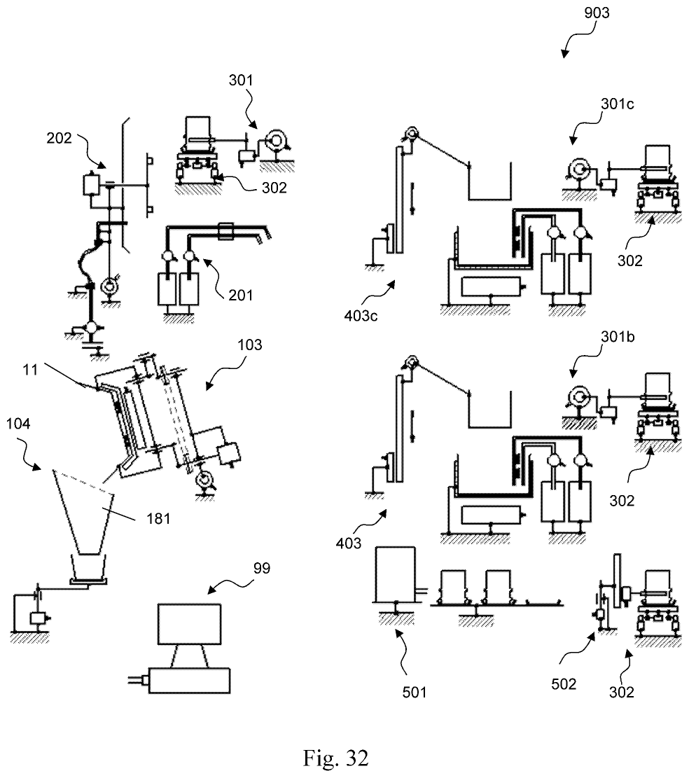

Then the semi-cooked foods dispensed from the cooking apparatuses 403 and 403c are further cooked by the cooking apparatus 103, possibly together with other ingredients, some of which are dispensed from an ingredient container on a holder of the transport system 302 by the first ingredient dispensing mechanism 301 (also see FIG. 10). Then a cooked food is produced in the cookware 11. Then, as shown in FIG. 32 (also see FIG. 6B), a cooked food may be dispensed into a food container 182 through the funnel 181.

The cookware cleaning mechanism 202 is positioned next to the cooking apparatus 103 and is configured to clean the cookware 11 (also see FIGS. 8B-8C).

The computer system 99 is configured to be connected to the mechanisms and devices 161. 16, 13, 172, 188, 212, 226, 234, 253, 344a, 344b, 348, 323, 411, 414, 47, 421, 212c; 212d; 501; and 502. The computer system 99 is also connected to the transport system 302 as to control the movements of the mini vehicles of the transport system 302.

In cooking system 903, the cooking apparatus 103 is positioned near the following mechanisms and apparatuses: the receiving apparatus 104; the cookware cleaning mechanism 202; the liquid dispensing mechanism 201, the cooking apparatus 403; the ingredient dispensing mechanism 301 which is next to the transport system 302, and the cooking apparatus 403c. The cooking apparatus 403 is positioned near the second ingredient dispensing mechanism 301b and the cooking apparatus 103. The cooking apparatus 403c is positioned near the third ingredient dispensing mechanism 301c and the cooking apparatus 103.

The computer system 99 is configured to comprise a memory. The computer system configured to store various data in the computer system's memory.

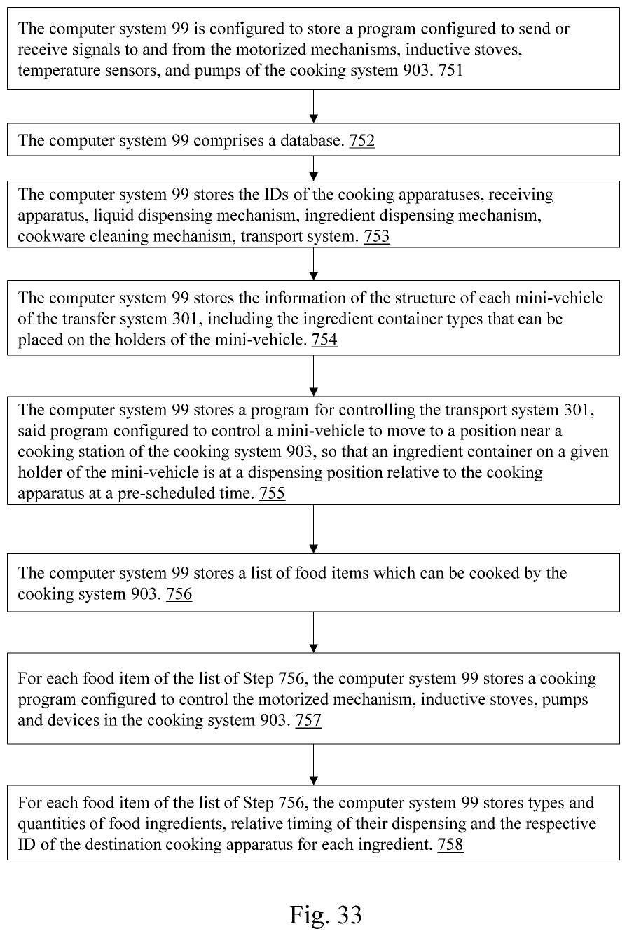

Referring to FIG. 33, the following tasks are performed by the computer system 99 prior to the operation of the cooking system 903.

In Step 751, the computer system 99 stores (in the computer system's memory) a program, configured to send or receive signals to and from the motorized mechanisms, inductive stoves, temperature sensors and pumps of the cooking system 903. The signals are used to control the operations of the motorized mechanisms, inductive stoves and pumps, or to communicate information from the temperature sensors to the computer system 99.

In Step 752, a database is installed in the computer system 99.

In Step 753, each of the cooking apparatuses, receiving apparatus, liquid dispensing mechanisms, ingredient dispensing mechanisms, cookware cleaning mechanism, transport system is assigned a unique ID. The computer system 99 stores the IDs of these apparatuses and mechanisms.

In Step 754, the computer system 99 stores the information of the structure of each mini-vehicle of the transport system 302, including the ingredient container types that can be placed on the holders of the mini-vehicle.

In Step 755, the computer system 99 stores a program for controlling the transport system 302. The program is configured to control a mini-vehicle so the mini-vehicle may move and stop at a pre-scheduled time at a position near a cooking apparatus of the cooking system 903, where a container on a given holder of the mini-vehicle is at a dispensing position relative to the cooking apparatus.

In Step 756, the computer system 99 stores a list of food items which may be cooked by the cooking system 903.

In Step 757, for each food item in the list of Step 756, the computer system 99 stores a cooking program configured to control the motorized mechanism, inductive stoves, pumps and devices in the cooking system 903.

In Step 758, for each food item in the list of Step 756, the computer system 99 stores types and quantities of food ingredients, relative timing of their dispensing and the respective ID of the destination cooking apparatus for each ingredient to be dispensed into; wherein the relative timing refers to the timing relative to the timing of the program of Step 757 corresponding to the food item. Food ingredients contained in a container is to be dispensed into a basked or cookware in the destination cooking apparatus.

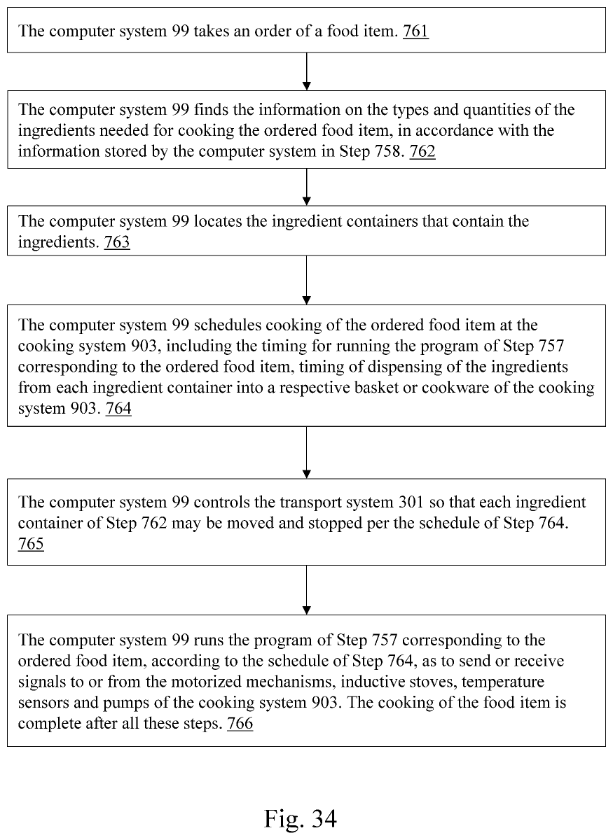

Referring to FIG. 34, the following tasks are routinely performed by the computer system 99 during the operation of the cooking system 903.

In Step 761, the computer system 99 takes an order of a food item. The order may be placed by a human either at the computer system 99, or at a computer which sends the order to the computer system 99.

In Step 762, for the ordered food item of Step 761, the computer system 99 finds the information the types and quantities of the ingredients needed for cooking the ordered food item. Such information was stored by the computer system 99 in Step 758.

In Step 763, the computer system 99 locates the ingredient containers that contain the food ingredients found in Step 762. The ingredients may be dispensed from some larger containers into said ingredient containers. Alternatively, ingredients may already be in the ingredient containers, and their locations had been stored in the memories of the computer system 99.

In Step 764, the computer system 99 schedules the cooking of the ordered food item at cooking system 903. The schedule includes the timing for running the program of Step 757 corresponding to the ordered food item. The schedule also includes the timing of dispensing of the ingredients from each ingredient container into a respective basket or cookware of the cooking system 903, in accordance to the stored information by the computer system 99 in Step 758.

In Step 765, the computer system 99 controls the transport system 302 so that each ingredient container of Step 762 may be moved and stopped per the schedule of Step 764.

In Step 766, The computer system 99 runs the program of Step 757 corresponding to the ordered food item, according to the schedule of Step 764, as to send or receive signals to or from the motorized mechanisms, inductive stoves, temperature sensors and pumps of the cooking system 903.

After all these steps, the cooking of the food item, including dispensing of the cooked food to a food container, is complete.

In some applications, the liquid in the cookware 45 of the cooking apparatus 403 of the cooking system 903 may comprise cooking oil, while the liquid in the cookware 45 of the cooking apparatus 403c may comprise water.

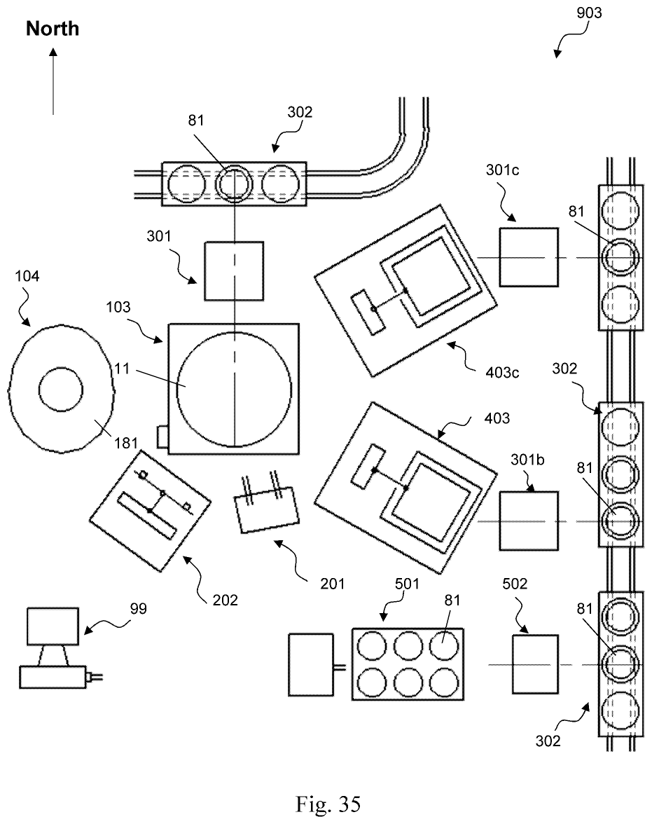

It should be noted that the 3-dimensional positioning of the mechanisms and apparatuses in the cooking system 903 can be done in various ways. For example, the receiving apparatus 104, the ingredient dispensing mechanism 301, the cooking apparatuses 403 and 403c may be respectively positioned on the Western, Northern and Eastern sides of the cookware 11 of the cooking apparatus 103; and the cookware cleaning mechanism 202, or the liquid dispensing mechanism 201 may be positioned in the Southwestern, or respectively Southeastern side of the cookware 11. The ingredient dispensing mechanism 301b or 301c may be positioned on the Eastern side of the cooking apparatus 403 or respectively 403c. See FIG. 35.

It should be noted that the transport system 302 in the above cooking systems may comprise a single connected system or a plurality of disconnected sub-systems. The mini-vehicles in the transport system may comprise different types of mini-vehicles. The ingredient containers may be configured differently for different types or quantities of ingredients.

It should be noted that the drawings are schematic in nature and they may not accurately represent the relative sizes and positions of various parts.

For the purpose of the present patent application, a motorized mechanism can describe any mechanism configured to produce a relative motion. A motorized mechanism can be powered by electricity, oil or other energy sources. A motorized mechanism may comprise a motor.

A motor may be an AC or DC motor, stepper motor, servo motor, inverter motor, pneumatic or hydraulic motor, etc. A motor may optionally further comprise a speed reducer, encoder, and/or proximity sensor.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

A rigid component described in the present patent application can be any type of solid component which has some degree of rigidity in an application, and there is no strict or quantitative requirement for the degree of rigidity. It should be noted that there is no perfect rigid component in our world, as there are always elastic, thermal, and other deformations in any physical subject. A rigid component may comprise one or more of the following: a bar, a tube, a beam, a plate, a board, a frame, a structure, a bearing housing, a shaft. A rigid component can be made by metal such as steel or aluminum, or a mixture of metals, an alloy, a reasonably rigid plastic, a wood, or by other materials, or by a combination of different types of materials.

Similarly, a rigid connection of two or more components can be a connection which has some degree of rigidity in an application, and there is no strict quantitative requirement for the degree of rigidity. A rigid connection may be a welding of two or more metal components. A rigid connection may be a bolting of two or more components; and so on. Clearly, a typical connection of a shaft and a bearing housing by a bearing (and accessories), for example, is not a rigid connection, since the shaft can rotate relative to the bearing housing.

A support component described in the present patent application can be a rigid component of any type, or a plurality of rigid components which are rigidly connected to each other. A support component may be moved or fixed relative to the ground. A link described in the present patent application can be a rigid component of any shape, or a plurality of rigid components which are rigidly connected to each other.

Most common bearings are ball bearings and roller bearings. However, a bearing in the present patent application can be of any type.

It should be noted that the drawings in the present patent application are schematic and may not be well scaled. The distances between various mechanisms and apparatuses may not be drawn in good scale. The 3-dimensional positioning of various mechanisms and apparatuses in a cooking system may be done in various ways.

In the cooking systems 901, 902 and 903, the ingredient dispensing mechanism 301, 301b, 301c and 301d may be configured differently. The container holders 311 of the transport system 302 which are next to different ingredient dispensing mechanisms may be configured to have different sizes. The ingredient containers 81 on different holders may be configured to have different sizes. The transport system 302 may comprise two or more sub-systems which are not connected with each other, and the mini vehicles may be configured differently on different subsystems.

On the other hand, the first ingredient dispensing mechanism 301 and the second ingredient dispensing mechanism 301b may be combined into one, using robot arms and other more complex mechanisms. Our mechanisms stand out as most economical.

The first liquid dispensing mechanism 201 and the second liquid dispensing mechanism 201b in the cooking system 902 may be configured differently. On the other hand, they can be combined into a single mechanism which comprises a motion mechanism configured to move the liquid pipes as to reach two different cookware.

It should also be noted that the first cooking apparatus 103 and the second cooking apparatus 103b in the cooking system 902 may be configured differently. The sizes and shapes of the cookware 11 can be different for different cooking apparatus. Likewise, the first cookware cleaning mechanism 202 and the second cookware cleaning mechanism 202b in the cooking system 902 may be configured differently.

Only a few examples and implementations are described. Other implementations, variations, modifications and enhancements to the described examples and implementations may be made without deviating from the spirit of the present invention. For example, the term cookware is used to generally refer to a device for containing or holding food ingredients during cooking. For the purpose of present patent application, a cookware can be a wok, a pot, a pan, a basket, a bowl, a container, a board, a rack, a net, or any object used to contain or otherwise hold food or food ingredients during a cooking process. The cooking also is not limited to any particular ethnic styles. The cooking may include but is not limited to frying (including stir frying), steaming, boiling, roasting, baking, smoking, microwaving etc. The cooking apparatus may or may not use a heater.

Similarly, a food container, ingredient container, or container, can be a bowl, a plate, a cup, a jar, a bottle, a flat board, a basket, a net, a wok, a pan, or any object used to contain or otherwise hold a food or food ingredients. A container can have a rather arbitrary geometric shape.

For the purpose of the present patent application, a connection of a computer (or computer system) and an electric or electronic component may compromise a wired and/or wireless connection between the computer (or computer system) and the electric or electronic device, as to allow the computer to communicate with said electric or electronic component. A connection of a computer (or computer system) and a mechanism or apparatus may comprise a wired and/or wireless connection between the computer (or computer system) and some (or all) of the electric or electronic components of the mechanism or apparatus as to allow the computer to communicate with said electric or electronic components.

What is claimed is:

1. A cooking system comprising:
a computer system configured to store a list of food items;
a first cooking apparatus comprising:
a first cookware configured to contain or otherwise hold food or food ingredients;
a first motion apparatus comprising:
a motion mechanism configured to move the first cookware as to stir or mix the food or food ingredients in the cookware during a cooking process, said motion mechanism being configured to be connected to the computer system as to allow the computer system to control said motion mechanism; and
an unloading mechanism configured to directly or indirectly move the first cookware as to dispense a cooked food from the first cookware to a container, said unloading motion mechanism being configured to be connected to the computer system as to allow the computer system to control said second unloading mechanism;
a first ingredient dispensing mechanism configured to dispense food ingredients into the first cookware, said first ingredient dispensing mechanism being configured to be connected to the computer system as to allow the computer system to control said first ingredient dispensing mechanism;
a second cooking apparatus comprising:
a second cookware comprising a basket configured to contain or otherwise hold food or food ingredients in an upright position;
a liquid container configured to contain a liquid and a heater configured to heat the liquid in the liquid container;
a second motion apparatus comprising:
a motion mechanism configured to move the second cookware as to place the food or food ingredients in the second cookware into the liquid of the liquid container, said motion mechanism being configured to be connected to the computer system as to allow the computer system to control said first motion mechanism; and
an unloading mechanism configured to directly or indirectly move the second cookware as to dispense a cooked or semi-cooked food from the second cookware to the first cookware, said unloading mechanism being configured to be connected to the computer system as to allow the computer system to control said unloading mechanism; and
a second ingredient dispensing mechanism configured to dispense food ingredients into the second cookware, said second ingredient dispensing mechanism being configured to be connected to the computer system as to allow the computer system to control said second ingredient dispensing mechanism

2. The cooking system of claim 1, wherein the first or second ingredient dispensing mechanism is configured to dispense virtually all food ingredients of a container at once.

3. The cooking system of claim 1, further comprising a cookware cleaning mechanism configured to clean the first cookware, said cleaning mechanism being configured to be connected to the computer system as to allow the computer system to control said cleaning mechanism.

4. The cooking system of claim 1, further comprising a storage apparatus configured to store containers of food ingredients.

5. The cooking system of claim 1, further comprising a transport system configured to move a container of food ingredients.

6. The cooking system of claim 5, wherein the transport system comprises a vehicle configured to move a container of food ingredients.

7. The cooking system of claim 5, wherein the transport system comprises a loading mechanism configured to load a container of food ingredients to a vehicle.

8. The cooking system of claim 1, wherein the second motion apparatus comprises a motion mechanism configured to produce a linear motion.

9. The cooking system of claim 1, wherein the second motion apparatus comprises a motion mechanism configured to produce a rotation.

10. The cooking system of claim 1, further comprising a motorized mechanism configured to move a container of cooked food, wherein said motorized mechanism is configured to be connected to the computer as to allow the computer to control said motorized mechanism.

11. A cooking system, comprising:
a computer system configured to store a list of food items;
a first cooking apparatus comprising:
a first cookware configured to contain or otherwise hold food or food ingredients; and
a first motion apparatus comprising:
a motion mechanism configured to move the first cookware as to stir or mix the food or food ingredients in the cookware during a cooking process, said first motion mechanism being configured to be connected to the computer system as to allow the computer system to control said first motion mechanism; and
an unloading mechanism configured to directly or indirectly move the first cookware as to dispense a cooked food from the first cookware to a container, said unloading mechanism being configured to be connected to the computer system as to allow the computer system to control said unloading mechanism;
a first cookware cleaning mechanism configured to clean the first cookware, said cleaning mechanism being configured to be connected to the computer system as to allow the computer system to control said cleaning mechanism;
a first ingredient dispensing mechanism configured to dispense food ingredients into the first cookware, said first ingredient dispensing mechanism being configured to be connected to the computer system as to allow the computer system to control said first ingredient dispensing mechanism;
a second cooking apparatus comprising:
a second cookware, configured to contain food or food ingredients in an upright position; and
a second motion apparatus comprising:
a motion mechanism configured to move the second cookware as to stir or mix the food or food ingredients in the cookware, said motion mechanism being configured to be connected to the computer system as to allow the computer system to control said motion mechanism; and
an unloading mechanism configured to directly or indirectly move the cookware as to dispense a cooked or semi-cooked food from the second cookware to the first cookware, said unloading mechanism being configured to be connected to the computer system as to allow the computer system to control said unloading mechanism; and
a second ingredient dispensing mechanism configured to dispense food ingredients into the second cookware, said second ingredient dispensing mechanism being configured to be connected to the computer system as to allow the computer system to control said second ingredient dispensing mechanism.

12. The cooking system of claim 11, wherein the first or second ingredient dispensing mechanism is configured to dispense virtually all food ingredients of a container at once.

13. The cooking system of claim 11, further comprising a cookware cleaning mechanism configured to clean the first or second cookware, said cleaning mechanism being configured to be connected to the computer system as to allow the computer system to control said cleaning mechanism.

14. The cooking system of claim 11, further comprising a storage apparatus configured to store containers of food ingredients.

15. The cooking system of claim 11, further comprising a transport system configured to move a container of food ingredients.

16. The cooking system of claim 15, wherein the transport system comprises a vehicle configured to move a container of food ingredients.

17. The cooking system of claim 15, wherein the transport system comprises a loading mechanism configured to load a container of food ingredients to a vehicle.

18. The cooking system of claim 11, wherein the second motion apparatus comprises a motion mechanism configured to produce a linear motion.

19. The cooking system of claim 11, wherein the second motion apparatus comprises a motion mechanism configured to produce a rotation.

20. The cooking system of claim 11, further comprising a motorized mechanism configured to move a container of cooked food, wherein said motorized mechanism is configured to be connected to the computer as to allow the computer to control said motorized mechanism.
